(19) United States
(12) Patent Application Publication
(10) Pub. No.: US 2026/0348443 A1
(43) Pub. Date: Nov. 5, 2026

(54) System and Method for Processing Springs and Product Made from Springs

(71) Applicant: RAIKU Packaging OÜ, Tallinn (EE)

(72) Inventors: Rain Randsberg, Tallinn, Harju maakond (EE); Tõnis Jalakas, Assaku, Rae vald Harjumaa (EE)

(21) Appl. No.: 19/488,277

(22) PCT Filed: Jun. 3, 2024
(86) PCT No.: PCT/EP2024/065219

§ 371 Date: Nov. 26, 2025

(30) Foreign Application Priority Data
Jun. 6, 2023 (EP) 23177712.9

(51) Int. Cl. F16F 1/364; F16F 3/04

(52) U.S. Cl. CPC F16F 1/364; F16F 3/04; F16F 2234/06; F16F 2238/028

(57) ABSTRACT

A product includes a plurality of layers of springs, each layer including a plurality of substantially parallel springs. A second layer of springs is placed on a first layer of springs, and the springs of the first layer are rotated by 60° to 120° with respect to the springs of the second layer. A system includes a product support system and a spring application system. The product support system includes a receiving level for receiving a plurality of layers of springs. Each layer includes a plurality of springs. The springs in each layer are substantially parallel. The receiving level includes a plurality of pins. The spring application system applies the plurality of springs to the product support system. A method includes placing a first plurality of springs in a first layer and placing a second plurality of springs in a second layer on the first layer of springs.

The present invention relates to the field of packaging materials and machinery for producing packaging materials. The present invention further relates to a method for making packaging materials.

In general, elastic coils, i.e., springs, are known in the art. Some approaches to manufacture springs from organic materials, such as wood or other at least partially woody plants have also been discussed. Also, some prior art documents propose fabrics and other structures made from such springs.

WO 2022/101457 A2 discloses a wooden spring comprising a strip of wood of medium thickness a, medium width b and stretched length l, characterized in that the coils of strips of wood are made using a method of making wooden springs with a helical shape, the mean diameter d of the coils and the average pitch s of the coils, wherein: a is 0,2-2 mm, b is 1-10 mm, l is 10-5000 mm, d is 6-60 mm, s is 4-40 mm. A wooden fabric interlaced of wooden springs comprising helix shaped strips of wood, the wooden springs are interlaced with at least two side by side wooden springs to form a wooden spring fabric.

U.S. Pat. No. 2,457,504A discloses wood veneer and/or plywood tubes, as well as a method and a device for manufacturing the same.

EP 3096653 B1 discloses a mattress manufactured with wooden springs made from non-compressed hard or semi-hard wood. Further, a method for making such wooden springs is disclosed.

While the prior art approaches may be satisfactory in some regards, they have certain shortcomings and disadvantages.

In particular, the mats disclosed in WO 2022/101457 A2 are made up from interlaced springs, which are difficult to produce in parallel. Further, the prior art does not provide for efficient machinery to produce mats made from such springs.

It is therefore an object of the invention to overcome or at least alleviate the shortcomings and disadvantages of the prior art. More particularly, it is an object of the present invention to provide an improved packaging material, system and method for producing the same.

It is another optional object of the present invention to provide a system for producing a packing material made from springs with an increased efficiency as well as a corresponding method.

In a first embodiment, a system for processing a plurality of springs, comprising a product support system, and a spring application system, is disclosed.

The springs may each comprise a strip of material spirally wound along a longitudinal axis of the spring. In other words, the springs may comprise a generally helical, spiral spring-like shape. In still other words, the springs may comprise a shape corresponding to a section of a curved surface of a cylinder delimited by two helixes of identical shape but with an angular or axial offset with respect to each other, wherein all points of the helixes are within the curved surface of the cylinder, and wherein the helixes extend from a first end of the curved surface to a second end of the curved surface.

The springs may comprise a substantially identical step in a substantially unbiased state. In other words, the springs may comprise a substantially identical distance between adjacent windings of the respective spring in a state where no external force apart from gravity is applied to the spring and wherein the spring is placed in a substantially horizontal position.

The system may comprise a control system configured for controlling an operation of the system. The control system may comprise a data-processing system.

The product support system may comprise a receiving level configured for receiving a plurality of layers of springs. Each layer may comprise a plurality of springs. The springs in each layer may be substantially parallel.

The springs in each layer may be are rotated by an angle of 90° with respect to the springs in an adjacent layer, particularly with respect to each adjacent layer. The rotation by the angle of 90° may relate to a state on the product support system. The springs may however assume a different angle with respect to springs of other layers after they are placed on the product support system, more particularly after they are placed on the receiving level, e.g., after being separated from the receiving level.

The receiving level may be configured for receiving layers of springs comprising at least two different orientations. Springs in a first orientation may be rotated by an angle of 90° with respect to springs in a second orientation.

The receiving level may comprise a plurality of pins.

The pins may be arranged along a rectangular grid. Particularly, the grid may be formed by lines parallel to the springs of the plurality of layers, such as longitudinal axes of the springs.

The pins may be substantially equally spaced along the grid by a grid step. The grid step may be defined as a distance between adjacent pins parallel to edges of the grid.

The grid step may comprise a length of 100 % to 160%, preferably 110% to 140% of a step of the springs in the substantially unbiased state.

A distance of adjacent pins in a first direction parallel to an orientation of springs in a first layer may be greater than the step of the springs of the first layer, preferably at least 20% greater than the step of the springs of the layer, more preferably at least 30% greater than the step of the springs of the layer.

The step of the plurality of springs of the layers may be substantially identical, and wherein a distance of adjacent pins in a second direction parallel to an orientation of springs in a second layer rotated by 90°with respect to the first layer is greater than the step of the springs of the second layer, preferably at least 20% greater than the step of the springs of the second layer, more preferably at least 30% greater than the step of the springs of the second layer.

The grid step may be greater than the step of the springs, preferably at least 20% greater than the step of the springs, more preferably at least at least 30% greater than the step of the springs.

The receiving level may comprise dimensions of at least 750 mm×750 mm, preferably at least 1000 mm×1000 mm, still more preferably at least 1250 mm×1250 mm, such as 1500 mm×1500 mm.

The grid step may be between 9 mm and 20 mm, particularly about 15 mm.

The pins comprise at least one of conical and substantially round heads.

The pins arranged along at least two rows of the grid may comprise domed bolt heads, such as button heads, round bolt heads or oval bolt heads. In other words, the pins arranged along the at least two rows may comprise a rounded top.

The pins may comprise a thread. The receiving level may further comprise a plurality of threaded holes for receiving the pins.

The product support system may further comprise a separating component configured for separating the plurality of springs from the receiving level.

The separating component may comprise a mesh. Particularly, the separating component may be configured for moving the mesh away from the receiving level and thus separating the plurality of coils from the pins. The mesh may for example be a wireframe.

The mesh may comprise holes. Each pin may be located in a projection of a hole on the receiving level. In other words, in a retracted position, the pin is located in the hole. In an extended position, the mesh may be extended further away from the receiving level than an upper end of the pin.

The spring application system may be configured for applying the plurality of springs to the product support system.

The spring application system may be configured for applying the plurality of springs to the product support system in an elongated state, preferably elongated at least 20% and still more preferably elongated at least 30% with respect to the unbiased state.

The spring application system may comprise a feed system and at least one application component.

The feed system may comprise at least one tube configured for receiving a spring of the plurality of springs. The tube may connect the at least one application component and at least one of an inlet and a storage component, such as a tray.

The system may comprise a compressed air supply. The feed system may be configured for moving a spring along the tube by means of compressed air.

The at least one of the inlet and the storage component may be located above the at least one application component. The feed system may comprise a section in which the spring is moved by gravity.

The at least one application component may comprise at least one or a plurality of guide element(s).

The spring application system may comprise a drive system.

The control system may be configured for controlling the drive system.

The system, particularly the drive system, may be configured for rotating the receiving level and the spring application system by an angle of at least 90° with respect to each other.

The system, particularly the drive system, may be configured for moving the at least one application component and the receiving level with respect to each other along an axis substantially perpendicular to the receiving level.

The system, particularly the drive system, may be configured for moving the at least one application component and the receiving level with respect to each other along at least one axis parallel to the receiving level.

The system may further comprise a trimming component.

The trimming component may be configured for trimming edges of the layers of springs.

The trimming component may comprise at least one blade. The system may be configured for trimming the edges of the layers of springs by means of the at least one blade.

The edge may be a straight edge. The edge may however also comprise another shape, such as a curved shape. Thus, optionally advantageously, a product with a curved shape, such as an elliptical or circular shape, may be obtained.

The blade may be a straight blade, e.g., to obtain a product comprising straight edges. The blade may however also comprise a different shape, such as a curved shape, e.g. so as to obtain a product of elliptical or circular shape.

The at least one application component may comprise at least one or a plurality of profiled wheel(s). The profiled wheel(s) may comprise teeth and/or forks around a circumference the profiled wheel(s).

The at least one profiled wheel may be at least one sprocket.

Teeth of the profiled wheel(s) may comprise an indentation towards a middle of each tooth.

The profiled wheel(s) may be the plurality of profiled wheels. The plurality of profiled wheels may be arranged as roller comprising several sets of teeth/forks, each being arranged around a respective circumference of the roller.

Adjacent wheels of the plurality of wheels may be spaced apart from each other by a distance by which adjacent pins are spaced from each other, particularly by the grid step.

The drive system may be configured for rotating the profiled wheel(s).

The profiled wheel(s) may be configured for transporting the springs. In other words, the profiled wheels may be configured for applying a force to the springs, particularly by direct contact.

The profiled wheel(s) may be configured for applying a force comprising a component substantially orthogonal to a longitudinal axis and/or line of the spring, e.g., a force towards the receiving level.

The guide element(s) may comprise a plurality of side supporting elements at sides of the profiled wheel(s) around circumference(s) of the profiled wheel(s).

At least one of the side supporting elements may be configured for separating adjacent profiled wheels from each other.

The at least one tube may be configured for providing a spring to the at least one profiled wheel(s).

The at least one tube may be a plurality of tubes. Each tube may be configured for providing a spring to one of the profiled wheels.

The guide element(s) may comprise at least one or a plurality of tube guide element(s) configured for guiding a spring from the at least one tube to the at least one profiled wheel.

The tube guide element(s) may be the plurality of tube guide elements. Each of the tube guide elements may be configured for guiding a spring from one of the tubes to one of the profiled wheels.

The at least one tube may be arranged at an angle of 15°-45° relative to the receiving level, preferably 25°-35°, and still more preferably at an angle of about 30°relative to the receiving level.

The profiled wheel(s) may comprise a pitch, particularly a circular pitch. The pitch may e.g. be in analogy to a pitch of a rack for a pinion.

The pitch of the profiled wheel(s) may substantially equal the grid step.

The pitch may be greater, preferably at least 20% greater, and still more preferably at least 30% greater than the step of the springs.

The profiled wheels may comprise substantially a same pitch.

The application system may comprise a synchronizing system configured for applying a force and/or torque onto a received spring in a direction opposite to a feeding direction, particularly for stretching a portion of the received coil.

The synchronizing system may be configured for applying the force and/or torque to the received spring by means of at least one friction brake configured for applying a torque to the profiled wheel(s).

The synchronizing system may be configured for controlling the drive system as to apply the force and/or the torque to the received spring by means of the profiled wheel(s).

The drive system may comprise at least one electric motor configured for rotating the profiled wheel(s).

The drive system may be configured for controlling a rotational position of the at least one electric motor.

The at least one electric motor may be configured for position control. For example, the at least one electric motor is at least one stepper motor.

The at least one application component may comprise a screw, particularly a translational screw.

The drive system may be configured for rotating the screw.

The guide element(s) may comprise at least two screw guide elements.

The drive system may be configured for moving the at least two screw guide elements.

The screw guide elements may be configured for assuming a closed configuration and an opened configuration. In the closed configuration, the screw guide elements may substantially enclose a section of the screw and form a clearance together with the screw. In other words, a volume may be defined between the screw guide elements and the screw along a length of least one of the screw guide elements and the screw.

The clearance may comprise dimensions sufficient to accommodate a spring, and further ensuring contact between said spring, the screw and the at least two screw guide elements. In other words, in the closed configuration, the screw guide elements may force the spring against the screw.

The screw and the screw guide elements may be configured for moving a spring axially along the screw from a first end of the screw to a second end of the screw opposite to the first end.

### The First End of the Screw May Comprise a Conical Shape.

The screw may comprise a profile in a cross-section along a length of the screw. The profile may comprise a generally tooth-like shape. The generally tooth-like shape may comprise a first flank proximate to the first end of the screw and a second flank proximate to the second end of the screw.

The first flank may comprise an angle a of 30° to 55°, preferably 35°-50°, such as about 45° with respect to an axis orthogonal to the length of the screw.

The second flank may comprise an angle B of at 10° to 30°, particularly 15°-25°, with respect to the axis orthogonal to the length of the screw.

The screw may comprise a friction element placed in a thread of the screw.

In other words, the friction element may be placed along a line of minimal diameter along the screw, i.e., along a line defined by a zone of minimal diameter in the profile of the screw.

The friction element may be made from at least one of polymer, metal and ceramic.

The friction element may for example comprise at least one of a roughened metallic surface, sandpaper and diamond papers onto metal. The latter option may optionally advantageously provide for increased resistance against wear.

The friction element may comprise an increased friction coefficient compared to a remainder of the thread of the screw.

The grid step and a lead of the screw may be substantially identical.

The screw may comprise a length greater than at least one outer edge of the grid, particularly greater than all four outer edges of the grid.

The at least two screw guide elements may be at least two movable shields.

In the closed configuration, the at least two screw guide elements enclose an angle of 110°-70°, preferably 100°-80°, and still more preferably about 90°.

The system may be configured for linearly moving at least one of the at least two screw guide elements, particularly the at least two screw guide elements, and thus assuming the opened and the closed configuration.

The system may comprise a first sensor configured for sensing a presence of a spring next to the first end of the screw.

The system may comprise a second sensor configured for sensing a presence of a spring next to the second end of the screw.

The system may comprise the plurality of springs.

The screw may comprise the length greater than a length of the springs, particularly greater than a length of the springs when held by the screw. In other words, the screw may comprise a length greater than a length of the springs in the elongated state.

The springs may comprise an outer diameter of 5 to 20 mm, preferably 8 mm to 15 mm, and still more preferably 10 mm to 12 mm in the substantially unbiased state.

The springs may be made of wood or an at least partially woody plant.

Also disclosed are a method and a computer program product. Advantages and details discussed in the context of the system may respectively apply also in the context of the method as well as the computer program product.

In a second embodiment, a method is disclosed. The method comprises providing a plurality of springs, placing a first plurality of the springs in a first layer, and placing a second plurality of springs in a second layer on the first layer of springs. The plurality of springs may comprise the first and the second plurality of springs.

The springs in each layer may be substantially parallel. The springs in the first layer are rotated by 60 to 120°, preferably by about 70 to 110°, and still more preferably by 80°to 100° with respect to the springs in the second layer.

Layer planes defined by the layers may be substantially parallel to each other.

In another embodiment, the method may comprise providing a plurality of springs, placing a first plurality of the springs in a first layer, placing a second plurality of springs in a second layer on the first layer of springs, and placing a third plurality of springs in a third layer on the second layer, wherein the springs in each layer are substantially parallel. The springs in the first layer are rotated by 80° to 100°, particularly by 85° to 95°, such as 90°, with respect to the springs in the second layer. Further, the springs in the second layer may be rotated by 80° to 100°, particularly by 85° to 95°, such as 90°, with respect to the springs in the third layer.

Particularly, layer planes defined by the layers may be substantially parallel to each other.

The person skilled in the art will easily understand that the above angular ranges discussed with respect to the method may relate to a state of the springs after the layers of springs are placed and/or at an end of the method.

In the preceding embodiment, the plurality of springs may comprise the first, second and third plurality of springs.

The method may comprise placing the springs on a receiving level, particularly on a plurality of pins.

The receiving level may be according to the receiving level discussed with respect to the system.

The pins may be arranged along a rectangular grid. Placing the first plurality of springs may comprise placing the springs of the first plurality on rows of pins of the grid spaced apart by at least one, particularly one, row of pins.

Placing the third plurality of springs may comprise placing the springs of the third plurality on some pins of the grid, spacing apart each pair of adjacent springs of the third layer by at least one, particularly one, row of pins.

In a projection orthogonal to the layer planes, the springs of the first and the third layer may be placed alternatingly.

In the projection orthogonal to the layer planes, a shortest distance between neighbouring springs of the first and the third layer differs from a shortest distance between neighbouring the springs of the second layer by at most 30%, preferably by at most 20%, still more preferably by at most 10%, and most preferably by at most 5%.

The method may comprise placing the first plurality of springs on the receiving level, subsequently rotating the receiving level with respect to the spring application system by 90°, and placing the second plurality of springs on the receiving level.

The method may also comprise placing the first plurality of springs on the receiving level, subsequently rotating the receiving level with respect to the spring application system by 90°, placing the second plurality of springs on the receiving level, subsequently rotating the receiving level with respect to the spring application system by 90°, and placing the third plurality of springs.

The rotation by the angle of 90° may relate to a state on the product support system and/or during execution of the method. The springs may however assume a different angle with respect to springs of other layers when they are not placed on the product support system, e.g., after separation from the product support system, and/or after the step of placing the springs on the receiving level is carried out.

The method may comprise rotating the receiving level with respect to a remainder of the system. The method may optionally not comprise rotating the spring application system with respect a remainder of the system.

Placing the springs may comprise pushing the springs on the pins of the receiving level.

Placing the pluralities of springs may comprise placing the springs in an elongated state in the respective layers. The springs may preferably be elongated by at least 20% and still more preferably elongated by at least 30% with respect to the unbiased state.

The method may comprise using the above-discussed system. For example, the method may comprise using the system according to embodiments comprising the screw.

Placing each plurality of springs in the respective layer may comprise moving the screw in a direction parallel to the layer planes and substantially perpendicular to a longitudinal axis of the springs in the respective layer.

Pushing the springs on the pins may comprise moving the screw in a direction substantially perpendicular to the layer planes towards the receiving level.

The method may also comprise using the system according to embodiments comprising the profiled wheel(s).

Placing each plurality of springs in the respective layer may comprise moving the receiving level in a direction parallel to the longitudinal axis of the springs in the respective layer.

Pushing the springs on the pins may comprise rotating the profiled wheel(s).

An axis of rotation of the profiled wheel(s) is substantially perpendicular to the movement of the receiving level in the direction parallel to the longitudinal axis of the spring in the respective layer.

The method may comprise separating the layers of springs from the receiving level, particularly without separating the layers of springs from each other.

The method may comprise separating the layers from the receiving level by means of the separating component.

The method may comprise separating the layers from the receiving level by moving the mesh away from the receiving level.

The method may comprise obtaining a mat of springs.

The method may comprise trimming edges of the mat.

The springs may comprise an outer diameter of 5 to 20 mm, preferably 8 mm to 15 mm, and still more preferably 10 mm to 12 mm in the substantially unbiased state.

The springs may comprise a length of 150 mm to 1500 mm, preferably 200 mm to 1000 mm in the substantially unbiased state, particularly a length of 200 mm to 900 mm in the substantially unbiased state.

The springs, more particularly windings of the springs, may comprise a substantially rectangular cross-section.

The springs may each comprise a flexible strip of material wound around a longitudinal axis of the spring.

The flexible strip may comprise a width of 1 mm to 20 mm, particularly 2 mm to 7 mm.

The springs may comprise a substantially identical step in a substantially unbiased state.

The step of the springs in the substantially unbiased state may be between 5 mm and 15 mm, preferably 7 and 12 mm, and still more preferably 8 and 10 mm.

The springs may be substantially made from wood and/or an at least partially woody plant, such as such as bamboo, willow, rattan, reed, cane and even dried palm leaves.

The method may comprise using the system according to any of the disclosed embodiments of the system.

The control system may be configured for controlling the system, particularly the drive system, so as to carry out the method according to any of the disclosed embodiments of the method.

In a third embodiment, a product is disclosed. The product comprises a plurality of at least two layers of springs, each layer comprising a plurality of substantially parallel springs. A second layer of springs may be placed on a first layer of springs. The springs of the first layer may be rotated by 60 to 120°, preferably by about 70 to 110°, and still more preferably by 80° to 100° with respect to the springs of the second layer.

The product may also comprise a plurality of at least three layers of springs, each layer comprising a plurality of substantially parallel springs. The second layer of springs may be placed on the first layer of springs, and a third layer of springs may be placed on the second layer.

Further, the springs of the first layer may be rotated by 80° to 100°, particularly by 85° to 95°, such as 90°, with respect to the springs of the second layer, and the springs of the second layer may be rotated by 80° to 100°, particularly by 85° to 95°, such as 90°, with respect to the springs of the third layer.

Optionally advantageously, the springs in the layers of the product comprising three layers may more consistently assume an angle of about 90°with respect to the springs of the adjacent layer(s) than the springs in the second product. Further, the product comprising three layers may comprise an improved robustness and/or stability of their shape and the orientation of the springs with respect to each other.

Optionally advantageously, the product comprising two layers may be easier to manufacture. Further, optionally advantageously, the product comprising two layers may comprise a lower area density than the product comprising three layers, while still comprising a generally regular shape.

In particular, the springs of different layers of the product comprising two layers may assume a generally rhombic shape. In other words, the springs in the second layer may be rotated by an angle of 60°-80° with respect to the springs in the first layer.

The person skilled in the art will easily understand that the product may comprise the above-described properties with respect to angles between the springs of different layers in an essentially unbiased state, e.g., when placed on a flat surface.

In a biased state, e.g., during a production process, the springs may comprise different angles with respect to each other.

The springs may each comprise a flexible strip of material spirally wound along a longitudinal axis of the spring. In other words, the springs, particularly their windings, may comprise a substantially rectangular cross-section.

The flexible strip may comprise a width of 3 mm to 7 mm, particularly 4 mm to 6 mm.

The springs may comprise a substantially identical step in a substantially unbiased state.

The springs may be substantially made from wood and/or an at least partially woody plant.

The springs may comprise an outer diameter of 5 to 20 mm, preferably 8 mm to 15 mm, and still more preferably 10 mm to 12 mm in the substantially unbiased state.

The springs may comprise a length of 150 mm to 1500 mm, preferably 200 mm to 1000 mm in the substantially unbiased state, particularly a length of 200 mm to 900 mm in the substantially unbiased state.

The step of the springs in the substantially unbiased state may be between 5 mm and 15 mm, preferably 7 and 12 mm, and still more preferably 8 and 10 mm.

In some embodiments, the springs of a same layer may not be interlaced. In particular, optionally, neither adjacent springs of different layers, nor springs of a same layer are interlaced. Thus, optionally advantageously, the product may be easier to produce.

The springs of each layer may be interlocked with springs of at least one of the other layers.

For a plurality of windings of the springs of the second layer, some of these windings may interlock with windings of springs of the first layer, and some of these windings may interlock with windings of springs of the third layer.

Layer planes defined by the layers of springs may be substantially parallel to each other.

In a projection orthogonal to the layer planes, the springs of the first and the third layer may be placed alternatingly.

In the projection orthogonal to the layer planes, the springs of the first layer may optionally not overlap with longitudinal axes of the springs of the third layer.

In the projection orthogonal to the layer planes, each spring of the first layer may optionally not overlap with a spring of the third layer by more than 40% of a projected surface of the spring of the first layer, preferably not by more than 20%, and still more preferably by not more than 10 %.

In the projection orthogonal to the layer planes, the springs of the first layer may optionally not overlap with the springs of the third layer.

In the projection orthogonal to the layer planes, in some optional embodiments, no winding of the plurality of windings of the second layer is contained in both of a winding of a spring of the first layer and a winding of a spring of the third layer. In other words, in some embodiments, each single winding of the plurality of windings of the second layer may correspond to a single winding of one spring of either the first or the third layer.

The product may be obtained by a method according to any of the method embodiments.

The product may be a mat.

The product may be a substantially rectangular mat.

In a substantially unbiased state of the product, e.g., when placed on a plane surface, distances of upmost points of windings of springs of an upmost layer, such as the second or the third layer, and lowermost points of adjacent windings of springs of a lowermost layer, such as the first layer, may differ by at most 10%, preferably by at most 5%, for 90 % of the windings of the product.

The springs may contain a woody material consisting of at least one of wood and a woody portion of an at least partially woody plant. A mass fraction of the woody material in the springs may amount to at least 50%, preferably at least 70% and still more preferably at least 90%.

The springs may be made from a veneer.

The following embodiments also form part of the invention.

### SYSTEM EMBODIMENTS

Below, embodiments of a system will be discussed. The system embodiments are abbreviated by the letter “S” followed by a number. Whenever reference is herein made to the “system embodiments”, these embodiments are meant.
S1. a System for Processing a Plurality of Springs, Comprising
   a product support system, and
   a spring application system.
S2. The system according to the preceding embodiment, wherein the springs each comprise a strip of material spirally wound along a longitudinal axis of the spring.
S3. The system according to any of the preceding embodiments, wherein the springs comprise a substantially identical step in a substantially unbiased state. In other words, the springs may comprise a substantially identical distance between adjacent windings of the respective spring in a state where no external force apart from gravity is applied to the spring and wherein the spring is placed in a substantially horizontal position.
S4. The system according to any of the preceding embodiments, wherein the system comprises a control system configured for controlling an operation of the system, wherein the control system comprises a data-processing system.
S5. The system according to any of the preceding embodiments, wherein the product support system comprises a receiving level configured for receiving a plurality of layers of springs,
   wherein each layer comprises a plurality of springs, and
   wherein the springs in each layer are substantially parallel.
S6. The system according to the preceding embodiment, wherein the springs in each layer are rotated by an angle of 90° with respect to the springs in an adjacent layer, particularly with respect to each adjacent layer.
S7. The system according to any of the two preceding embodiments, wherein the receiving level is configured for receiving layers of springs comprising at least two different orientations, wherein springs in a first orientation are rotated by an angle of 90° with respect to springs in a second orientation.
S8. The system according to any of the preceding embodiment with the features of S5, wherein the receiving level comprises a plurality of pins.
S9. The system according to any of the preceding embodiments with the features of S8 and S5, wherein the pins are arranged along a rectangular grid, particularly a grid formed by lines parallel to the springs of the plurality of layers, such as longitudinal axes of the springs.
S10. The system according to the preceding embodiment, wherein the pins are substantially equally spaced along the grid by a grid step, particularly wherein the grid step is defined as a distance between adjacent pins parallel to edges of the grid.
S11. The system according to the preceding embodiment, wherein the grid step comprises length of 100% to 160%, preferably 110% to 140% of a step of the springs in the substantially unbiased state.
S12. The system according to any of the preceding embodiments with the features of S3, wherein a distance of adjacent pins in a first direction parallel to an orientation of springs in a first layer is greater than the step of the springs of the first layer, preferably at least 20% greater than the step of the springs of the layer, more preferably at least 30% greater than the step of the springs of the layer.
S13. The system according to the preceding embodiment, wherein the step of the plurality of springs of the layers is substantially identical, and wherein a distance of adjacent pins in a second direction parallel to an orientation of springs in a second layer rotated by 90° with respect to the first layer is greater than the step of the springs of the second layer, preferably at least 20% greater than the step of the springs of the second layer, more preferably at least 30% greater than the step of the springs of the second layer.
S14. The system according to any of the preceding embodiments with the features of S3 and S10, wherein the grid step is greater than the step of the springs, preferably at least 20% greater than the step of the springs, more preferably at least at least 30% greater than the step of the springs.
S15. The system according to any of the preceding embodiments with the features of S5, wherein the receiving level comprises dimensions of at least 750 mm×750 mm, preferably at least 1000 mm×1000 mm, still more preferably at least 1250 mm×1250 mm, such as 1500 mm×1500 mm.
S16. The system according to any of the preceding embodiments with the features of S 10, wherein the grid step is between 9 mm and 20 mm, particularly about 15 mm.
S17. The system according to any of the preceding embodiments with the features of S8, wherein the pins comprise at least one of conical and substantially round heads.
S18. The system according to any of the preceding embodiments with the features of S8 and S9, wherein the pins arranged along at least two rows of the grid comprise domed bolt heads, such as button heads, round bolt heads or oval bolt heads. In other words, in this embodiment, the pins arranged along the at least two rows comprise a rounded top.
S19. The system according to any of the preceding embodiments with the features of S8, wherein the pins comprise a thread, and wherein the receiving level further comprises a plurality of threaded holes for receiving the pins.
S20. The system according to any of the preceding embodiments with the features of S5, wherein the product support system further comprises a separating component configured for separating the plurality of springs from the receiving level.
S21. The system according to the preceding embodiment, wherein the separating component comprises a mesh, and wherein particularly, the separating component is configured for moving the mesh away from the receiving level and thus separating the plurality of coils from the pins.
S22. The system according to the preceding embodiment and with the features of S8, wherein the mesh comprises holes, and wherein each pin is located in a projection of a hole on the receiving level.
S23. The system according to any of the preceding embodiments, particularly with the features of S5, wherein the spring application system is configured for applying the plurality of springs to the product support system.
S24. The system according to the preceding embodiment, wherein the spring application system is configured for applying the plurality of springs to the product support system in an elongated state, preferably elongated at least 20% and still more preferably elongated at least 30% with respect to the unbiased state.
S25. The system according to any of the preceding embodiments, wherein the spring application system comprises a feed system and at least one application component.
S26. The system according to the preceding embodiment, wherein the feed system comprises at least one tube configured for receiving a spring of the plurality of springs, particularly wherein the tube connects the at least one application component and at least one of an inlet and a storage component, such as a tray.
S27. The system according to the preceding embodiment, wherein the system comprises a compressed air supply and wherein the feed system is configured for moving a spring along the tube by means of compressed air.
S28. The system according to any of the two preceding embodiments, wherein the at least one of the inlet and the storage component is located above the at least one application component and wherein the feed system comprises a section in which the spring is moved by gravity.
S29. The system according to any of the preceding embodiments with the features of S25, wherein the at least one application component comprises at least one or a plurality of guide element(s).
S30. The system according to any of the preceding embodiments with the features of S25, wherein the spring application system comprises a drive system.
S31. The system according to the preceding embodiment and with the features of S4, wherein the control system is configured for controlling the drive system.
S32. The system according to any of the preceding embodiments with the features of S5, particularly with the features of S30, wherein the system, particularly the drive system, is configured for rotating the receiving level and the spring application system by an angle of at least 90° with respect to each other.
S33. The system according to any of the preceding embodiments with the features of S5 and S25, particularly with the features of S30, wherein the system, particularly the drive system, is configured for moving the at least one application component and the receiving level with respect to each other along an axis substantially perpendicular to the receiving level.
S34. The system according to any of the preceding embodiments with the features of S5 and S25, particularly with the features of S30, wherein the system, particularly the drive system, is configured for moving the at least one application component and the receiving level with respect to each other along at least one axis parallel to the receiving level.
S35. The system according to any of the preceding embodiments, wherein the system further comprises a trimming component.
S36. The system according to the preceding embodiment and S5, wherein the trimming component is configured for trimming edges of the layers of springs.
S37. The system according to any of the two preceding embodiments, wherein the trimming component comprises at least one blade, and wherein the system is configured for trimming the edges of the layers of springs by means of the at least one blade.
S38. The system according to any of the preceding embodiments with the features of S25, wherein the at least one application component comprises at least one or a plurality of profiled wheel(s), wherein the profiled wheel(s) comprise teeth and/or forks around a circumference the profiled wheel(s).
S39. The system according to the preceding embodiment, wherein the at least one profiled wheel is at least one sprocket.
S40. The system according to any of the two preceding embodiments, wherein teeth of the profiled wheel(s), comprise an indentation towards a middle of each tooth.
S41. The system according to any of the preceding embodiments with the features of S38, wherein the profiled wheel(s) is the plurality of profiled wheels.
S42. The system according to the preceding embodiment and with the features of at least one of S3a and S9, wherein adjacent wheels of the plurality of wheels are spaced apart from each other by a distance by which adjacent pins are spaced from each other, particularly by the grid step.
S43. The system according to any of the preceding embodiments with the features of S38 and S30, wherein the drive system is configured for rotating the profiled wheel(s).
S44. The system according to any of the preceding embodiments with the features of S38, wherein the profiled wheel(s) are configured for transporting the springs.
S45. The system according to any of the preceding embodiments with the features of S38 and S29, wherein the guide element(s) comprise a plurality of side supporting elements at sides of the profiled wheel(s) around circumference(s) of the profiled wheel(s).
S46. The system according to the preceding embodiment and with the features of S41, wherein at least one of the side supporting elements separates adjacent profiled wheels from each other.
S47. The system according to any of the preceding embodiments with the features of S76 and S38, wherein the at least one tube is configured for providing a spring to the at least one profiled wheel(s).
S48. The system according to the preceding embodiment and with the features of S41, wherein the at least one tube is a plurality of tubes, and wherein each tube is configured for providing a spring to one of the profiled wheels.
S49. The system according to any of the preceding embodiments with the features of S47 and S29, wherein the guide element(s) comprise at least one or a plurality of tube guide element(s) configured for guiding a spring from the at least one tube to the at least one profiled wheel.
S50. The system according to the preceding embodiment and with the features of S41, wherein the tube guide element(s) are the plurality of tube guide elements, wherein each of the tube guide elements is configured for guiding a spring from one of the tubes to one of the profiled wheels.
S51. The system according to any of the preceding embodiments with the features of S47 and S 5, wherein the at least one tube is arranged at an angle of 15°-45° relative to the receiving level, preferably 25°-35°, and still more preferably at an angle of about 30° relative to the receiving level.
S52. The system according to any of the preceding embodiments with the features of S38, particularly with the features S24, wherein the profiled wheel(s) comprise a pitch, particularly a circular pitch.
S53. The system according to the preceding embodiment, wherein the pitch of the profiled wheel(s) substantially equals the grid step.
S54. The system according to any of the two preceding embodiments, wherein the pitch is greater, preferably at least 20% greater, and still more preferably at least 30% greater than the step of the springs.
S55. The system according to any of the preceding embodiments with the features of S41, wherein the profiled wheels comprise substantially a same pitch.
S56. The system according to any of the preceding embodiments with the features of S25, wherein the application system comprises a synchronizing system configured for applying a force and/or torque onto a received spring in a direction opposite to a feeding direction, particularly for stretching a portion of the received coil.
S57. The system according to the preceding embodiment, wherein the synchronizing system is configured for applying the force and/or torque to the received spring by means of at least one friction brake configured for applying a torque to the profiled wheel(s).
S58. The system according to any of the two preceding embodiments and with the features of S42, wherein the synchronizing system is configured for controlling the drive system as to apply the force and/or the torque to the received spring by means of the profiled wheel(s).
S59. The system according to any of the preceding embodiments and with the features of S42, wherein the drive system comprises at least one electric motor configured for rotating the profiled wheel(s).
S60. The system according to the preceding embodiment, wherein the drive system is configured for controlling a rotational position of the at least one electric motor.
S61. The system according to any of the preceding embodiments with the features of S58, wherein the at least one electric motor is configured for position control, e.g., wherein the at least one electric motor is at least one stepper motor.
S62. The system according to any of the preceding embodiments with the features of S25, wherein the at least one application component comprises a screw, particularly a translational screw.
S63. The system according to the preceding embodiment and with the features of S30, wherein the drive system is configured for rotating the screw.
S64. The system according to any of the two preceding embodiment and with the features of S29, wherein the guide element(s) comprise at least two screw guide elements.
S65. The system according to the preceding embodiment and with the features of S30, wherein the drive system is configured for moving the at least two screw guide elements.
S66. The system according to any of the two preceding embodiments, wherein the screw guide elements are configured for assuming a closed configuration and an opened configuration,
   wherein in the closed configuration, the screw guide elements substantially enclose a section of the screw and form a clearance together with the screw, wherein the clearance comprises dimensions
(a) sufficient to accommodate a spring, and
(b) ensuring contact between said spring, the screw and the at least two screw guide elements.
S67. The system according to any of the preceding embodiments with the features of S62, wherein the screw and the screw guide elements are configured for moving a spring axially along the screw from a first end of the screw to a second end of the screw opposite to the first end.
S68. The system according to the preceding embodiment, wherein the first end of the screw comprises a conical shape.
S69. The system according to any of the preceding embodiments with the features of S67, wherein the screw comprises a profile in a cross-section along a length of the screw,
   wherein the profile comprises a generally tooth-like shape,
   wherein the generally tooth-like shape comprises a first flank proximate to the first end of the screw and a second flank proximate to the second end of the screw.
S70. The system according to the preceding embodiment, wherein the first flank comprises an angle a of 30° to 55°, preferably 35°-50°, such as about 45° with respect to an axis orthogonal to the length of the screw.
S71. The system according to any of the two preceding embodiments, wherein the second flank comprises an angle β of at 10° to 30°, particularly 15°-25°, with respect to the axis orthogonal to the length of the screw.
S72. The system according to any of the preceding embodiments with the features of S62, wherein the screw comprises a friction element placed in a thread of the screw.

In other words, the friction element may be placed along a line of minimal diameter along the screw, i.e., along a line defined by a zone of minimal diameter in the profile of the screw.
S73. The system according to the preceding embodiment, wherein the friction element is made from at least one of polymer, metal and ceramic.
S74. The system according to any of the two preceding embodiments, wherein the friction element comprises an increased friction coefficient compared to a remainder of the thread of the screw.
S75. The system according to any of the preceding embodiments with the features of S62 and S10, wherein the grid step and a lead of the screw are substantially identical.
S76. The system according to any of the preceding embodiments with the features of S62 and S8, wherein the screw comprises a length greater than at least one outer edge of the grid, particularly greater than all four outer edges of the grid.
S77. The system according to any of the preceding embodiments with the features of S64, wherein the at least two screw guide elements are at least two movable shields.
S78. The system according to any of the preceding embodiments with the features of S64, wherein in the closed configuration, the at least two screw guide elements enclose an angle of 110°-70°, preferably 100°-80°, and still more preferably about 90°.
S79. The system according to any of the preceding embodiments with the features of S64, wherein the system is configured for linearly moving at least one of the at least two screw guide elements, particularly the at least two screw guide elements, and thus assuming the opened and the closed configuration.
S80. The system according to any of the preceding embodiments with the features of S67, wherein the system comprises a first sensor configured for sensing a presence of a spring next to the first end of the screw.
S81. The system according to any of the preceding embodiments with the features of S67, wherein the system comprises a second sensor configured for sensing a presence of a spring next to the second end of the screw.
S82. The system according to any of the preceding embodiments, wherein the system comprises the plurality of springs.
S83. The system according to the preceding embodiment and with the features of S75, wherein the screw comprises the length greater than a length of the springs, particularly greater than a length of the springs when held by the screw. In other words, the screw may comprise a length greater than a length of the springs in the elongated state.
S84. The system according to any of the preceding embodiments, wherein the springs comprise an outer diameter of 5 to 20 mm, preferably 8 mm to 15 mm, and still more preferably 10 mm to 12 mm in the substantially unbiased state.
S85. The system according to any of the preceding embodiments, wherein the springs are made of wood or an at least partially woody plant.

### METHOD EMBODIMENTS

Below, embodiments of a method will be discussed. The method embodiments are abbreviated by the letter “M” followed by a number. Whenever reference is herein made to the “method embodiments”, these embodiments are meant.
M1. A Method, Comprising
   providing a plurality of springs,
   placing a first plurality of the springs in a first layer, and
   placing a second plurality of springs in a second layer on the first layer of springs,
   wherein the springs in each layer are substantially parallel,
   wherein the springs in the first layer are rotated by 60 to 120°, preferably by about 70 to 110°, and still more preferably by 80° to 100° with respect to the springs in the second layer, and
   wherein particularly, layer planes defined by the layers, are substantially parallel to each other.
M2. A Method, Comprising
   providing a plurality of springs,
   placing a first plurality of the springs in a first layer,
   placing a second plurality of springs in a second layer on the first layer of springs, and
   placing a third plurality of springs in a third layer on the second layer,
   wherein the springs in each layer are substantially parallel,
   wherein the springs in the first layer are rotated by 80° to 100°, particularly by 85° to 95°, such as 90°, with respect to the springs in the second layer,
   wherein the springs in the second layer are rotated by 80° to 100°, particularly by 85° to 95°, such as 90°, with respect to the springs in the third layer, and
   wherein particularly, layer planes defined by the layers, are substantially parallel to each other.
M3. The method according to any of the preceding embodiments, wherein the method comprises placing the springs on a receiving level, particularly on a plurality of pins.
M4. The method according to the preceding embodiment, wherein the receiving level is according to S5 or any of its dependent embodiments.
M5. The method according to any of the preceding method embodiments with the features of M3, wherein the pins are arranged along a rectangular grid, and
   wherein placing the first plurality of springs comprises placing the springs of the first plurality on rows of pins of the grid spaced apart by at least one, particularly one, row of pins.
M6. The method according to the preceding embodiment and with the features of M2, wherein placing the third plurality of springs comprises placing the springs of the third plurality on some pins of the grid, spacing apart each pair of adjacent springs of the third layer by at least one, particularly one, row of pins.
M7. The method according to any of the two preceding embodiments, wherein in a projection orthogonal to the layer planes, the springs of the first and the third layer are placed alternatingly.
M8. The method according to any of the preceding method embodiments with the features of M2, wherein in the projection orthogonal to the layer planes, a shortest distance between neighbouring springs of the first and the third layer differs from a shortest distance between neighbouring the springs of the second layer by at most 30%, preferably by at most 20%, still more preferably by at most 10%, and most preferably by at most 5%.
M9. The method according to any of the preceding method embodiments, wherein the method comprises using the system according to any of the system embodiments with the features of S5,
   wherein the method comprises
   placing the first plurality of springs on the receiving level,
   subsequently rotating the receiving level with respect to the spring application system by 90°, and
   placing the second plurality of springs on the receiving level.
M10. The method according to any of the preceding method embodiments with the features of M2, wherein the method comprises using the system according to any of the system embodiments with the features of S5,
   wherein the method comprises
   placing the first plurality of springs on the receiving level,
   subsequently rotating the receiving level with respect to the spring application system by 90°,
   placing the second plurality of springs on the receiving level,
   subsequently rotating the receiving level with respect to the spring application system by 90°, and
   placing the third plurality of springs.
M11. The method according to any of the two preceding embodiments, wherein the method comprises rotating the receiving level with respect to a remainder of the system, and wherein the method does not comprise rotating the spring application system with respect a remainder of the system.
M12. The method according to any of the preceding method embodiments, wherein the method comprises using the system with the features of S8, wherein placing the springs comprises pushing the springs on the pins of the receiving level.
M13. The method according to any of the preceding method embodiments, wherein placing the pluralities of springs comprises placing the springs in an elongated state in the respective layers, wherein the springs are preferably elongated by at least 20% and still more preferably elongated by at least 30% with respect to the unbiased state.
M14. The method according to any of the preceding method embodiments, wherein the method comprises using the system with the features of S62,
   wherein placing each plurality of springs in the respective layer comprises moving the screw in a direction parallel to the layer planes and substantially perpendicular to a longitudinal axis of the springs in the respective layer.
M15. The method according to any of the preceding method embodiments with the features of M12, wherein the method comprises using the system with the features of S62,
   wherein pushing the springs on the pins comprises moving the screw in a direction substantially perpendicular to the layer planes towards the receiving level.
M16. The method according to any of the preceding method embodiments, wherein the method comprises using the system with the features of S38,
   wherein placing each plurality of springs in the respective layer comprises moving the receiving level in a direction parallel to the longitudinal axis of the springs in the respective layer.
M17. The method according to any of the preceding method embodiments with the features of M12, wherein the method comprises using the system with the features of S38, wherein pushing the springs on the pins comprises rotating the profiled wheel(s).
M18. The method according to the two preceding embodiments, wherein an axis of rotation of the profiled wheel(s) is substantially perpendicular to the movement of the receiving level in the direction parallel to the longitudinal axis of the spring in the respective layer.
M19. The method according to any of the preceding method embodiments with the features of M3, wherein the method comprises separating the layers of springs from the receiving level, particularly without separating the layers of springs from each other.
M20. The method according to the preceding embodiment, wherein the method comprises using the system according to S20, wherein the method comprises separating the layers from the receiving level by means of the separating component.
M21. The method according to the preceding embodiment and with the features of S21, wherein the method comprises separating the layers from the receiving level by moving the mesh away from the receiving level.
M22. The method according to any of the preceding method embodiments, wherein the method comprises obtaining a mat of springs.
M23. The method according to the preceding embodiment, wherein the method comprises trimming edges of the mat.
M24. The method according to the preceding embodiment, wherein the method comprises using the system according to S35.
M25. The method according to any of the preceding method embodiments, wherein the springs comprise an outer diameter of 5 to 20 mm, preferably 8 mm to 15 mm, and still more preferably 10 mm to 12 mm in the substantially unbiased state.
M26. The method according to any of the preceding method embodiments, wherein the springs comprise a length of 150 mm to 1500 mm, preferably 200 mm to 1000 mm in the substantially unbiased state, particularly a length of 200 mm to 900 mm in the substantially unbiased state.
M27. The method according to any of the preceding method embodiments, wherein the springs comprise a substantially rectangular cross-section.
M28. The method according to any of the preceding method embodiments, wherein the springs each comprise a flexible strip of material wound around a longitudinal axis of the spring.
M29. The method according to the preceding embodiment, wherein the flexible strip comprises a width of 1 mm to 20 mm, particularly 2 mm to 7 mm.
M30. The method according to any of the preceding method embodiments, wherein the springs comprise a substantially identical step in a substantially unbiased state.
M31. The method according to the preceding embodiment, wherein the step of the springs in the substantially unbiased state is between 5 mm and 15 mm, preferably 7 and 12 mm, and still more preferably 8 and 10 mm.
M32. The method according to any of the preceding embodiments, wherein the springs are substantially made from wood and/or an at least partially woody plant.
M33. The method according to any of the preceding method embodiments, wherein the method comprises using the system according to any of the system embodiments.
S86. The system according to any of the preceding system embodiments with the features of S4 and S30, wherein the control system is configured for controlling the system, particularly the drive system, so as to carry out the method according to any of the method embodiments.

### PRODUCT EMBODIMENTS

Below, embodiments of a product will be discussed. These embodiments are abbreviated by the letter “P” followed by a number. Whenever reference is herein made to the “product embodiments”, these embodiments are meant.
P1. A product, comprising a plurality of at least two layers of springs, each layer comprising a plurality of substantially parallel springs,
   wherein a second layer of springs is placed on a first layer of springs,
   wherein the springs of the first layer are rotated by 60 to 120°, preferably by about 70 to 110°, and still more preferably by 80° to 100° with respect to the springs of the second layer.
P2. A product, comprising a plurality of at least three layers of springs, each layer comprising a plurality of substantially parallel springs,
   wherein a second layer of springs is placed on a first layer of springs, and a third layer of springs is placed on the second layer,
   wherein the springs of the first layer are rotated by 80° to 100°, particularly by 85° to 95°, such as 90°, with respect to the springs of the second layer, wherein the springs of the second layer are rotated by 80° to 100°, particularly by 85° to 95°, such as 90°, with respect to the springs of the third layer.
P3. The product according to any of the preceding product embodiments, wherein the springs each comprise a flexible strip of material spirally wound along a longitudinal axis of the spring.

In other words, the springs may comprise a substantially rectangular cross-section.
P4. The product according to the preceding embodiment, wherein the flexible strip comprises a width of 3 mm to 7 mm, particularly 4 mm to 6 mm.
P5. The product according to any of the preceding product embodiments, wherein the springs comprise a substantially identical step in a substantially unbiased state.
P6. The product according to any of the preceding product embodiments, wherein the springs are substantially made from wood and/or an at least partially woody plant.
P7. The product according to any of the preceding product embodiments, wherein the springs comprise an outer diameter of 5 to 20 mm, preferably 8 mm to 15 mm, and still more preferably 10 mm to 12 mm in the substantially unbiased state.
P8. The product according to any of the preceding product embodiments, wherein the springs comprise a length of 150 mm to 1500 mm, preferably 200 mm to 1000 mm in the substantially unbiased state, particularly a length of 200 mm to 900 mm in the substantially unbiased state.
P9. The method according to any of the preceding product embodiments, wherein the step of the springs in the substantially unbiased state is between 5 mm and 15 mm, preferably 7 and 12 mm, and still more preferably 8 and 10 mm.
P10. The product according to any of the preceding product embodiments, wherein the springs of a same layer are not interlaced, particularly wherein neither adjacent springs of different layers, nor springs of a same layer are interlaced.
P11. The product according any of the preceding product embodiments, wherein the springs of each layer are interlocked with springs of at least one of the other layers.
P12. The product according to any of the two preceding embodiments and with the features of P2, wherein for a plurality of windings of the springs of the second layer, some of these windings interlock with windings of springs of the first layer, and some of these windings interlock with windings of springs of the third layer.
P13. The product according to any of the preceding product embodiments, wherein layer planes defined by the layers of springs are substantially parallel to each other.
P14. The product according to the preceding embodiment and with the features of P2, wherein in a projection orthogonal to the layer planes, the springs of the first and the third layer are placed alternatingly.
P15. The product according to any of the embodiments with the features of P13 and P2, wherein in the projection orthogonal to the layer planes, the springs of the first layer do not overlap with longitudinal axes of the springs of the third layer.
P16. The product according to any of the embodiments with the features of P13 and P2, wherein in the projection orthogonal to the layer planes, each spring of the first layer does not overlap with a spring of the third layer by more than 40% of a projected surface of the spring of the first layer, preferably not by more than 20%, and still more preferably by not more than 10 %.
P17. The product according to any of the embodiments with the features of P13 and P2, wherein in the projection orthogonal to the layer planes, the springs of the first layer do not overlap with the springs of the third layer.
P18. The product according to any of the product embodiments with the features of P2, P12 and P13, wherein further, in the projection orthogonal to the layer planes, no winding of the plurality of windings of the second layer is contained in both of a winding of a spring of the first layer and a winding of a spring of the third layer. In other words, each single winding of the plurality of windings of the second layer corresponds to a single winding of one spring of either the first or the third layer.
P19. The product according to any of the product embodiments, wherein the product is obtained by a method according to any of the method embodiments.
P20. The product according to any of the preceding product embodiments, wherein the product is a mat.
P21. The product according to the preceding embodiment, wherein the product is a substantially rectangular mat.
P22. The product according to any of the preceding product embodiments, wherein in a substantially unbiased state of the product, distances of upmost points of windings of springs of an upmost layer, such as the second or the third layer, and lowermost points of adjacent windings of springs of a lowermost layer, such as the first layer, differ by at most 10%, preferably by at most 5%, for 90 % of the windings of the product.
P23. The product according to any of the preceding product embodiments, wherein the springs contain a woody material consisting of at least one of wood and a woody portion of an at least partially woody plant, wherein a mass fraction of the woody material in the springs amounts to at least 35%, preferably at least 50% and still more preferably 70%.
24. The product according to any of the preceding product embodiments, wherein the springs are made from a veneer.

Exemplary features of the invention are further detailed in the figures and the below description of the figures.

### BRIEF DESCRIPTION OF THE FIGURES

FIGS. 1, 2, 3, 4a and 4b show different representations of a product.

FIG. 5 shows a system for processing springs, particularly an application component.

FIGS. 6a-6c show a method for generating the product.

FIGS. 7a-7c show details of an embodiment of the system, particularly of the application component.

FIG. 8-9 show another embodiment of the application component.

FIGS. 10a-11b show another embodiment of the method.

FIGS. 12a-12c show another embodiment of the system.

FIG. 13 shows another embodiment of the product.

### DETAILED FIGURE DESCRIPTION

For the sake of clarity, some features may only be shown in some figures, and others may be omitted. However, also the omitted features may be present, and the shown and discussed features do not need to be present in all embodiments.

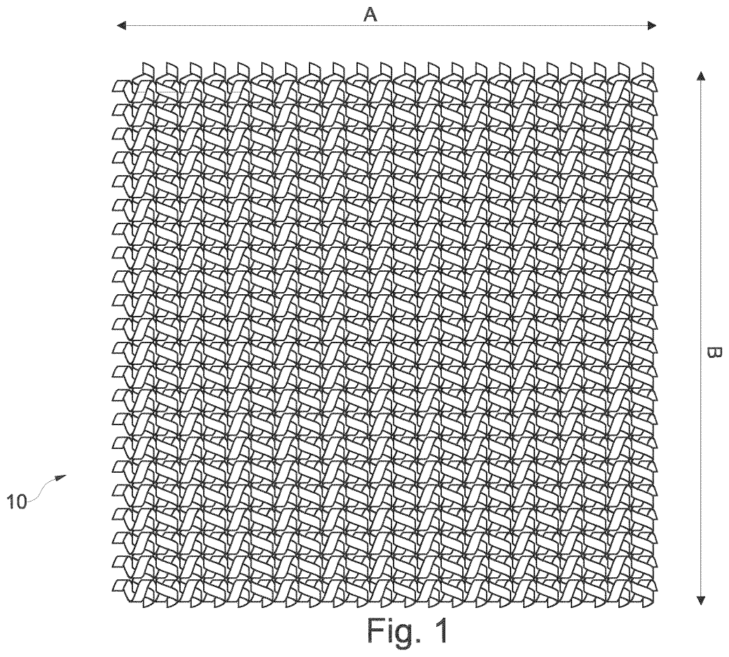

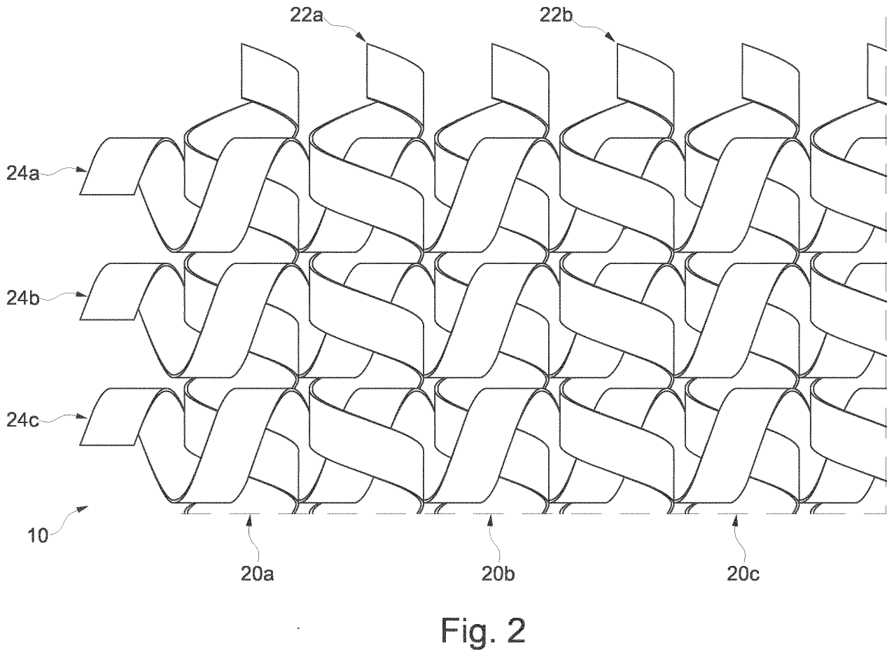

FIG. 1 shows a product 10. The product 10 comprises outer dimensions A and B in an essentially unbiased state. The product may be in the essentially unbiased state, e.g., if it is placed on a horizontal plane and not biased by outer forces. In the example of FIG. 1, the product 10 is a mat. The mat comprises a plurality of layers of springs.

FIG. 2 shows a section of the product 10 in greater detail. As can be seen in FIG. 2, the product 10 comprises a plurality of interlocking springs 20a, 20b, 20c, 22a, 22b, 24a, 24b, 24c. The product 10 in FIG. 2 comprises three layers of parallel springs. A first layer comprises springs 20a, 20b and 20c. A second layer comprises springs 24a, 24b and 24c. A third layer comprises springs 22a, 22b.

In FIG. 2, a projection orthogonal to layer planes defined by the layers is shown. The layer planes substantially comprise longitudinal axes of the springs of the respective layers. As can be seen in FIG. 2, the springs in each layer are substantially parallel.

Further, as can be seen in FIG. 2, the springs 24a, 24b, 24c in the second layer are rotated by 90° with respect to the springs 20 a, 20 b, 20 c, 22 a, 22 b of the first and third layer. In the example of FIG. 2, the layer planes are substantially parallel.

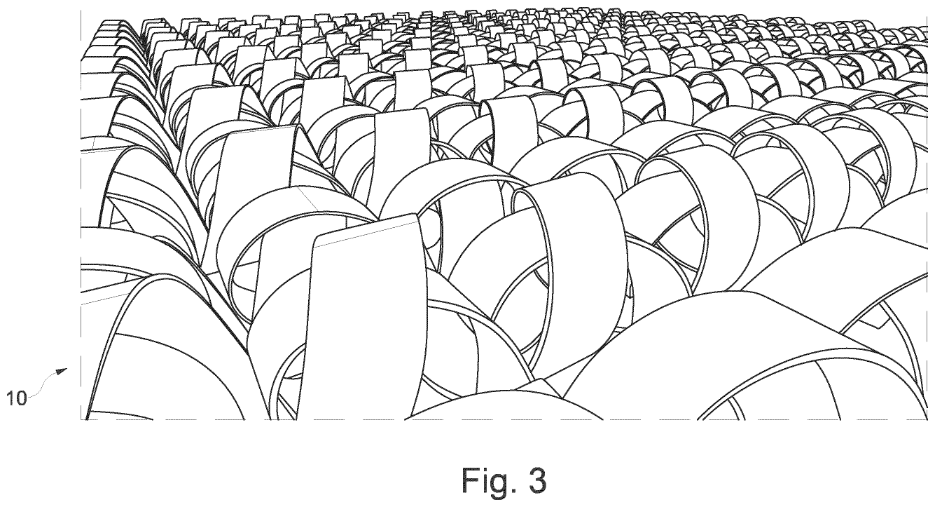

FIG. 3 shows another perspective of the product 10.

The springs of the product 10 of FIGS. 1-4 each comprise a flexible strip of material. The strip is spirally wound around a longitudinal axis of the spring. In other words, the strip encloses a cylindrical helix. A wider surface of the strip is facing towards and away from a middle axis of the helix.

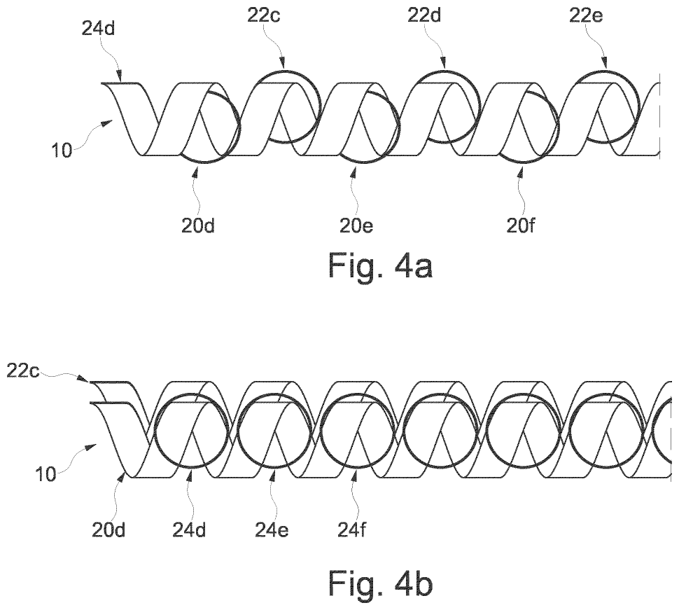

FIGS. 4a and 4b show cross-sections of the product. FIG. 4a shows a cross-section of the product 10, wherein the section plane is oriented parallel to the longitudinal axis of a spring 24d of the second layer. As can be seen, the springs 20d, 20e, 20f of the first layer are placed below the springs 24d of the second layer. The springs of the second layer 24 are place below the springs 22c, 22d, 22e of the third layer. FIG. 4b shows a cross-section whose section plane is oriented parallel to the longitudinal axis of the springs 22c, 20d of the first and third layer. As can be seen, the springs of the second layer 24d, 24e, 24f hold together the springs 22c, 20d of the first and third layer.

The product 10 shown in the Figures is made up of interlocking springs. As can be seen, the springs do not interlace. The springs can form the product 10 simply because of their elasticity and shape. In the Figures, the springs comprise substantially same geometrical parameters, particularly same diameters and steps. The springs of different layers can however comprise different lengths, in particular if the product's dimensions A and B differ from each other.

In the example of FIG. 1, the springs comprise an outer diameter of 10-12 mm in the unbiased state. However, the person skilled in the art easily understands that the product 10 can be equally formed of smaller of bigger springs.

The springs in FIG. 1 are made from wood. They can however also be made from a woody part of an at least partially woody plant, such as bamboo, willow, rattan, reed, cane and even dried palm leaves.

In the example of FIG. 1, the springs comprise a length of 200-300 mm in the unbiased state and when they are not yet processed to obtain the product. By the methods disclosed e.g. in WO 2022/101457 A2 , which is incorporated herein in its entirety, springs comprising a length of up to 900 mm in the unbiased state can be obtained from veneers comprising e.g. sizes of 2500 mm×1200 mm.

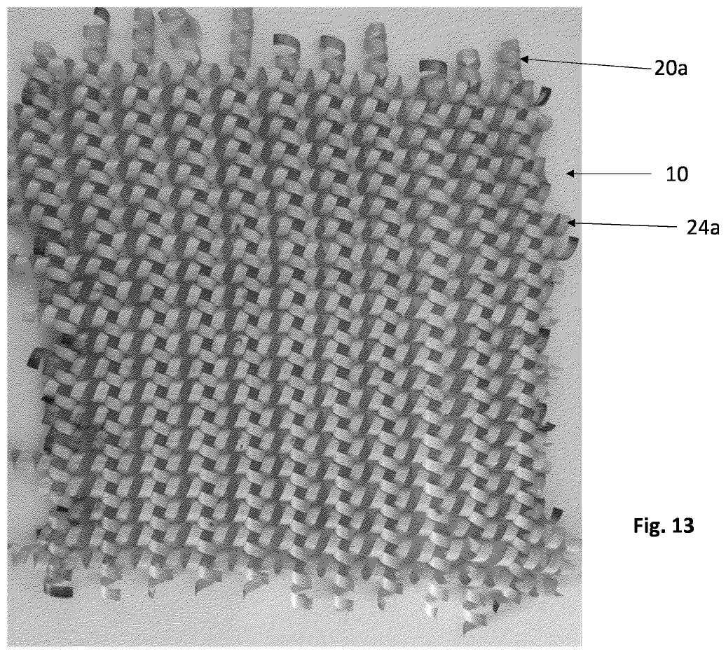

FIG. 13 shows another embodiment of the product 10, comprising only two layers. As can be seen, the product comprises parallel springs 20 of the first layer of springs and parallel springs 24 of the second layer of springs.

The product 10 shown in FIGS. 1-4b comprising three layers of parallel springs may optionally advantageously comprise an improved robustness in comparison to the product 10 shown in FIG. 13 and comprising two layers.

Also, optionally advantageously, the orientation of the springs of the first layer with respect to the springs of the second layer amount more consistently to 90° in the product comprising three layers than in the product comprising two layers. Also, the springs of the layers of product 10 shown in FIGS. 1-4b may optionally advantageously, comprise less deviations from a parallel orientation with respect to other springs of a same layer.

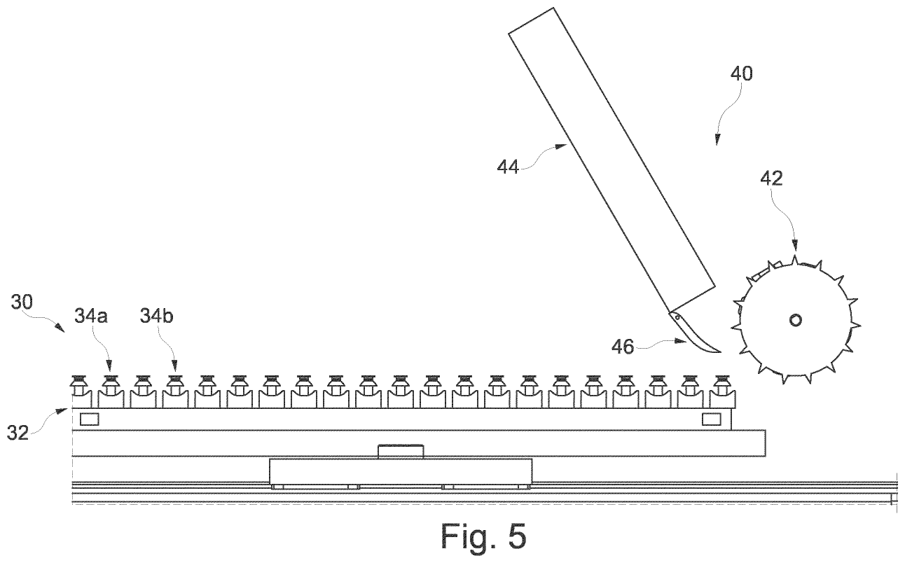

FIG. 5 shows a system 30 for processing springs. The system comprises a receiving level 32. The receiving level 32 receives layers of parallel springs as discussed above. The springs are applied to the receiving level 32 in an elongated state, in other words in a stretched state.

The system 30 comprises an application system 40. The application system 40 is configured for applying springs to the receiving level 32. The application system 40 comprises an application component 42. The application component 42 in the example of FIG. 5 is a sprocket. The sprocket is moved by a drive system (not shown in FIG. 5).

Additionally, the system comprises at least one tube 44 connecting the application component and a spring supply, such as a tray or a storage container.

The application component comprises at least one guide element 46. The guide element 46 in FIG. 5 is a pushdown blade configured for guiding a spring to the application component 42. The guide element 46 in FIG. 5 optionally guides the spring to the sprocket and ensures that each tooth interlocks with a winding of the spring. Further, the guide element 46 in Fig. optionally avoids that springs fall through tube 44 on the receiving level 32.

The receiving level comprises a plurality of pins 34a, 34b. The pins 34a, 34b are arranged in a grid-like pattern. In the example of FIG. 5, the pins are spaced apart from each other by a constant grid step along both directions of the grid. The grid step may be greater than a step of the springs. Thus, optionally, the springs are applied to the receiving level 32 in an elongated state, hence allowing to apply the different layers to each other.

In the example of FIG. 5, the system 30 is adapted from processing springs comprising an outer diameter of 10.5 mm, a width of the strip of material of 5 mm and a step of 9 mm. In this example, the grid step, i.e., the shortest distance of adjacent pins, amounts to 15 mm.

The pins 34a, 34b comprise spherical heads or generally domed heads. Each wood spring winding is supported by pin. However, when all springs are applied, each pin may support windings of different springs. For example, a pin supports a winding of a spring of the first and the second layer, or of the second and the third layer.

The heads of the pins 324a, 34b may be identical. They may however also be different.

The system is configured for moving the application component 40 with respect to the receiving level 32 along an axis parallel to the receiving level by means of the drive system (not shown). In the example of FIG. 5, the drive system comprises a belt drive and an electric motor configured for moving the receiving level 32 along said axis. However, additionally or alternatively, the drive system may comprise a ball screw, a threaded spinde, a rack and a pinion and/or a trapezoid screw configured for moving the receiving level 32.

The application component 42 of FIG. 5 stretches the springs by forcing the windings in teeth of the sprocket. Alternatively, another profiled wheel, e.g. equipped with forks, can be used. The profiled elements of the application component 42, in the example of FIG. 5 the teeth, comprise a pitch greater than the step of the springs in the unbiased state. In the example of FIG. 5, the pitch of the teeth equals the grid step. Thus, optionally advantageously, the spring is stretched so that it can be applied on the pins 34a, 34b of the receiving level. The system is further configured for moving the application component along an axis substantially perpendicular to the receiving level 32 by means of the drive system (not shown).

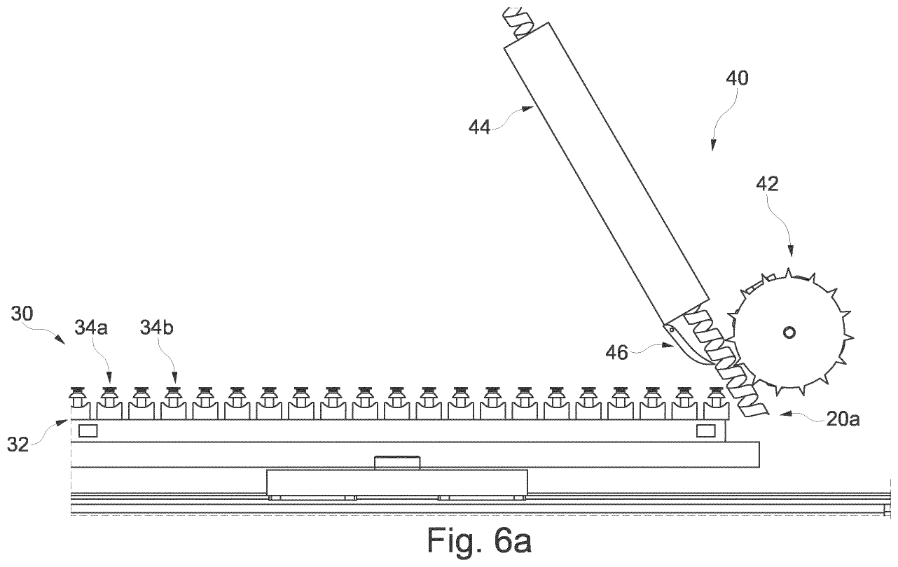

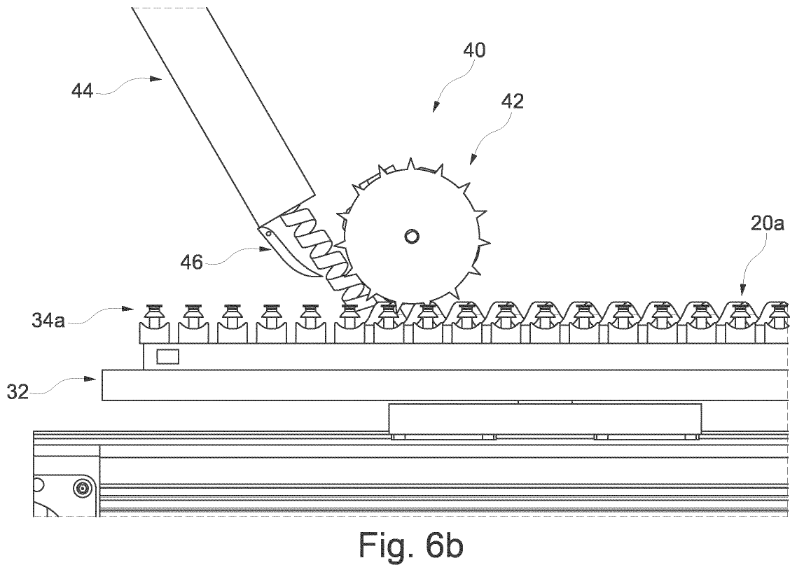

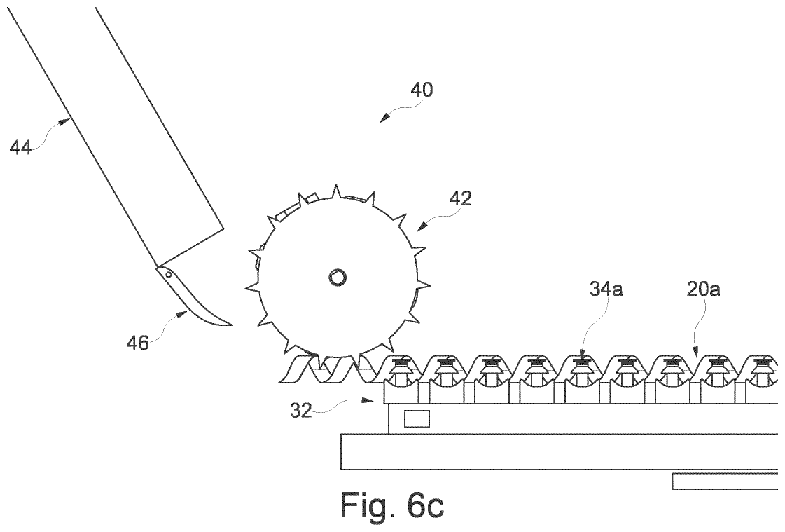

FIGS. 6a-6c illustrate an exemplary method for obtaining the product 10 with the system 30.

The exemplary method comprises feeding the spring into the tube 44. The feeding can be performed by a manual, mechanical or pneumatic feeding system. The feeding can also be performed manually.

In a subsequent step, the system lowers the application component 42 to the receiving level. The sprocket is located next to receiving level 32. Thus, optionally, a vertical position of a spring applied by the application component 42 is directly above the receiving level 32.

Further, the drive system, more particularly, a drive component (not shown in FIGS. 6a-6c) moves the spring in the application component 42 a few windings forward. Thus, optionally, an end of the spring 20a protrudes out of the application component 42. A result of the step is illustrated in FIG. 6a.

In another step, a movement along an axis parallel to the receiving level 32 is started. The spring 20a is rolled onto the pins 34a, 34b by the application component 42 moving along the receiving level. This state is shown in FIGS. 6b and 6c.

The synchronizing system supports application of the springs 20a on the pins 34a, 34b of the receiving level. For example, the profiled wheel(s) can comprise a mechanical brake braking the profiled wheel(s) and thus facilitating that each winding is placed on a corresponding pin.

In the example of FIGS. 5 to 7c, the synchronizing system is however implemented by means of an electric motor applying a torque or force onto the profiled wheel(s). In the example of FIGS. 6a-6c, the drive system is configured for controlling a rotational position of the electric motor, thus optionally advantageously facilitating a correct placement of the springs on the pins.

If the application component comprises one profiled wheel, the profiled wheel returns and is moved to another row of the receiving level 32 and another spring is placed and the step is repeated until the first layer of springs 20a, 20b, 20c, 20d, 20e, 20f is generated. If multiple application components 42 are used in parallel, the first layer can be finished in one stroke. The person skilled in the art will easily understand that this can be implemented by at least one of the receiving level and the profiled wheel moving with respect to a remainder of the system.

As set out above, between each of the springs 20a, 20b, 20c, 20d, 20e, 20f of the first layer, there is a free row of pins 34a, 34b.

Then, the receiving level 32 is rotated by 90° with respect to the application system 40. In the example of FIGS. 6a-6c, this is achieved by rotating the receiving level 32 with respect to a remainder of the system.

The second layer of springs 24a, 24b, 24c, 24d, 24e, 24f is placed on the receiving level 32. In contrast to the first layer, there are no free rows between adjacent springs of the second layer. In case of multiple application components 42, this can e.g. be achieved by two strokes.

The receiving level is then again rotated by 90° with respect to the application system.

The third layer of springs 22a, 22b, 22c, 22d, 22e is applied to the receiving level as set out with respect to the first layer.

Thus, the product 10 is obtained. However, the springs of the product 10 are still in an elongated state.

The product is separated from the receiving level 32 by a separating component (not shown). The separating component is for example a mesh or a wireframe. During application of the springs, the mesh or wireframe is located between the pins. For separation, the mesh or wireframe is moved away from the receiving level 32 and hence lifts the product 10.

The wireframe may comprise metal bars. The metal bars may be arranged in parallel within a frame. In such a case, the wireframe may for example comprise the shape of a grating. The metal bars may also comprise a first set of metal bars oriented in parallel to each other and a second set of metal bars oriented perpendicularly to the first set, thus yielding a grid-like wireframe. The wireframe may for example also be made from a sheet of metal, e.g., by piercing.

Edges of the product are trimmed by means of a trimming component, such as a blade or a saw. The blade can for example be integrated into a guillotine-like mechanism.

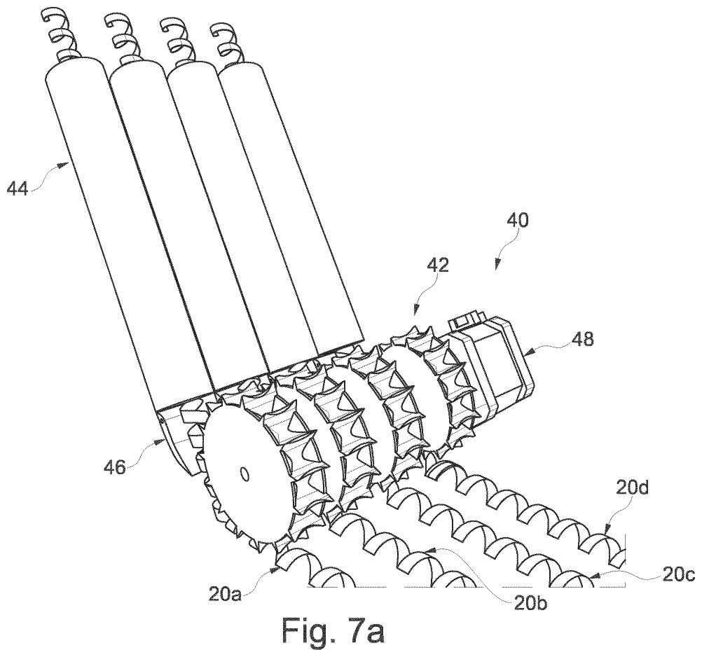

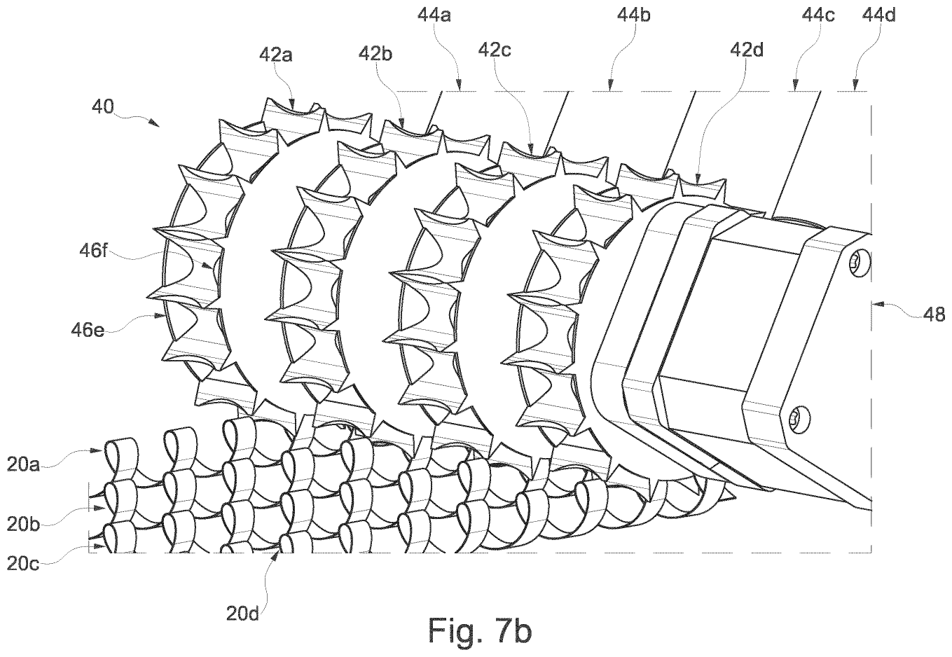

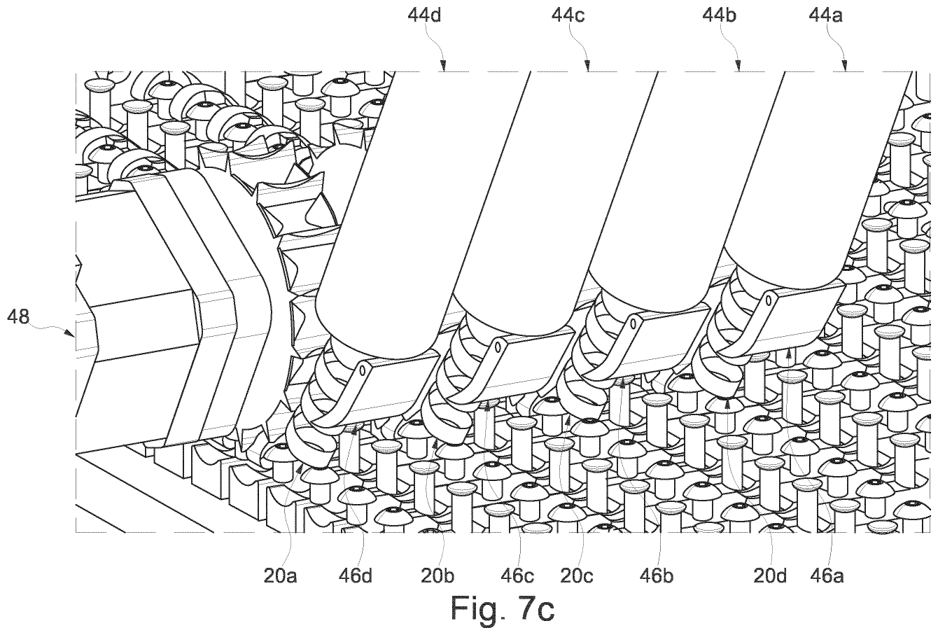

FIGS. 7a-7c show an embodiment of the application system 40 comprising a plurality of application components 42a, 42b, 42c, 42d. The plurality of application components may be advantageous, as the product 10 may be obtained with less movements along the receiving level and thus be produced faster.

The application components 42a, 42b, 42c, 42d are spaced apart by about one grid step of the receiving level 32. Thus, the first and third layer of springs can easily be obtained.

The application components 42a, 42b, 42c, 42d are profiled wheels. The guide elements 46e, 47f in FIG. 7b comprise side support elements. The side support elements optionally restrict lateral movements of the springs with respect to the profiled wheels 42a, 42b, 42c, 42d and thus reduce a likelihood of errors during spring application.

Further, as can be seen on FIG. 7b, the profiles of the wheels comprise an inward-bound curved shape. The curved shape optionally advantageously facilitates introduction of a front end of the springs to the profiled wheels. Further, the curved shape optionally advantageously centres the springs in the profiled wheels.

FIG. 7c further shows an example of the guide elements 46 46a, 46b, 46c, 46d, which comprise tube guide elements connecting the tubes 44a, 44b, 44c, 44d and the application components 42a, 42b, 42c, 42d.

Further, FIGS. 7a-7c show a drive component 48 of the drive system. The drive component 48 is implemented as electric motor. The drive component 48 is configured for driving the application components 42a, 42b, 42c, 42d, more precisely for rotating the profiled wheels.

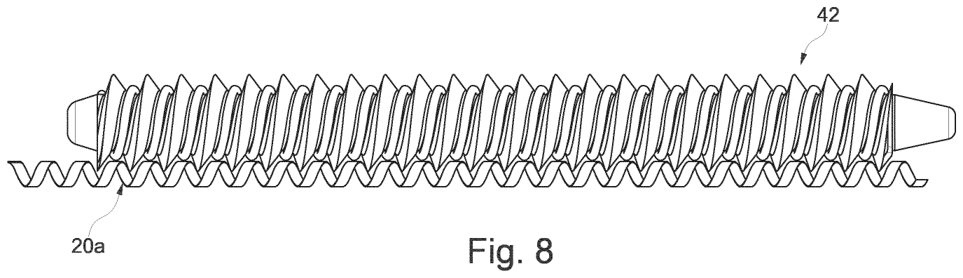

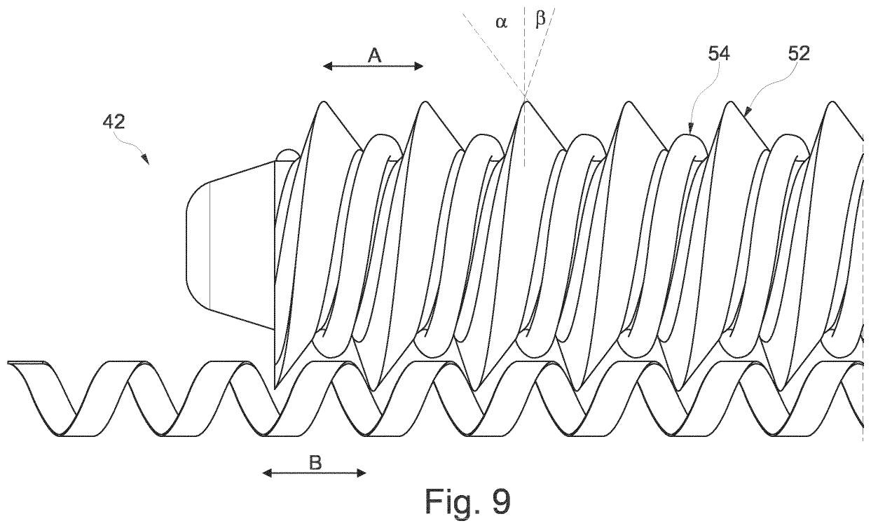

FIGS. 8 and 9 show another application component 42. The application component 42 comprises a translational screw 52 configured for moving and elongating a spring 20a.

In FIG. 9, the step B of the spring 20a is shown, which equals a distance between start points of two subsequent windings of the spring 20. Further, the pitch A of the screw 52 is shown. In FIG. 9, a single-started screw is shown. Thus, the pitch A equals the lead of the screw 52. The lead of the screw 52 equals the grid step of the pins 34a, 34b of the receiving level 32.

The lead of the screw 52 is greater than the step of the spring 20a in an unbiased state (not shown). Thus, when held in the threads of the screw 52, the spring 20a is elongated.

The screw comprises length greater than a length of the elongated spring. Thus, optionally advantageously, free movements of an end of the spring may be inhibited and reliability may thus be increased.

In the examples of FIG. 8-12c, the screw 52 is according to a common screw conveyor design.

The application component 42 in FIGS. 8-12c is configured for transporting the spring 20a from the storage to the receiving level 32. As set out above, the spring 20a is stretched. Hence, pretension is applied to the spring 20a. Optionally advantageously, the screw 52 defines uniform steps between each spring winding.

The screw 52 comprises a conical tip on a first end, i.e., a right end in FIG. 8. Thus, optionally advantageously, an introduction of the spring and the screw 52 is facilitated and the system provides a more reliable function.

The screw 52 comprises a tooth-like shaped profile, as can be seen in FIG. 9. In FIG. 9, the tooth-like shaped profile is a triangular saw profile.

A first flank, i.e., a flank facing the first end of the screw 52, comprises an angle a of 30°-45° with respect to an axis orthogonal to the length of the screw 52. This shape optionally advantageously supports stretching of the spring 20a.

A second flank, i.e., a flank facing a second end of the screw 52 opposite to the first end comprises an angle β of at most 10° with respect to the axis orthogonal to the length of the screw. Thus, moving the spring forwards in the screw is facilitated, inhibiting a backward movement of the screw.

Further, the application component 42 comprises a friction element 54 winding around the screw 52 in an innermost portion of the thread.

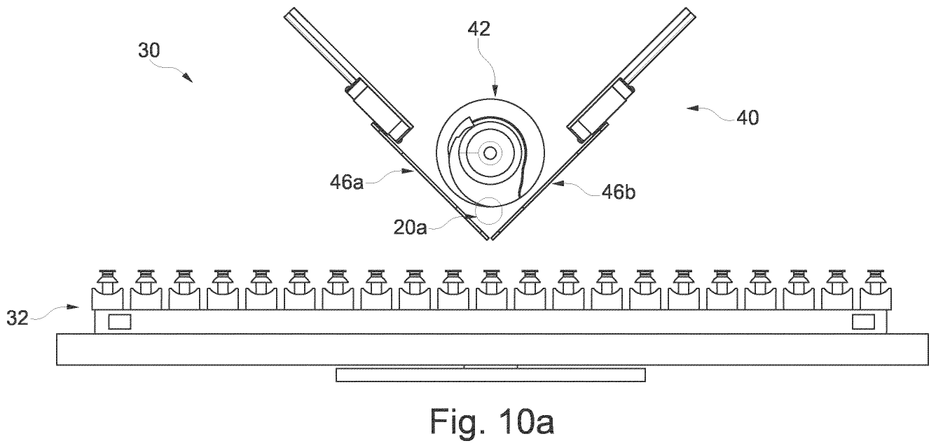

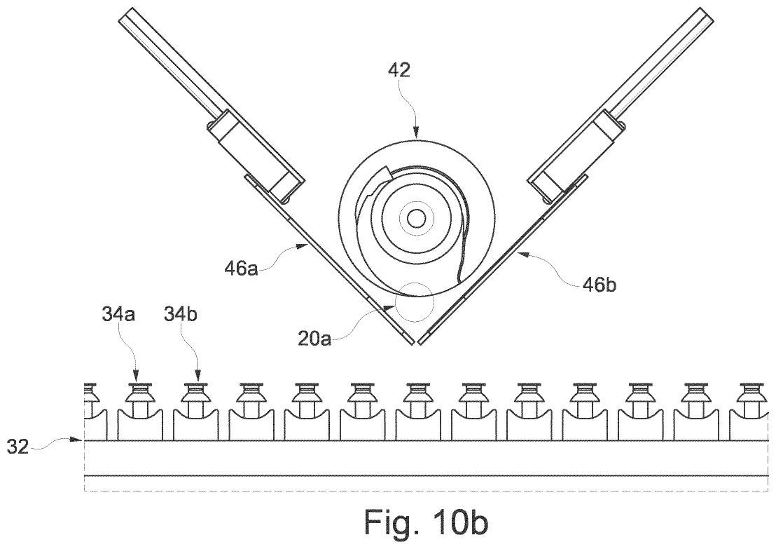

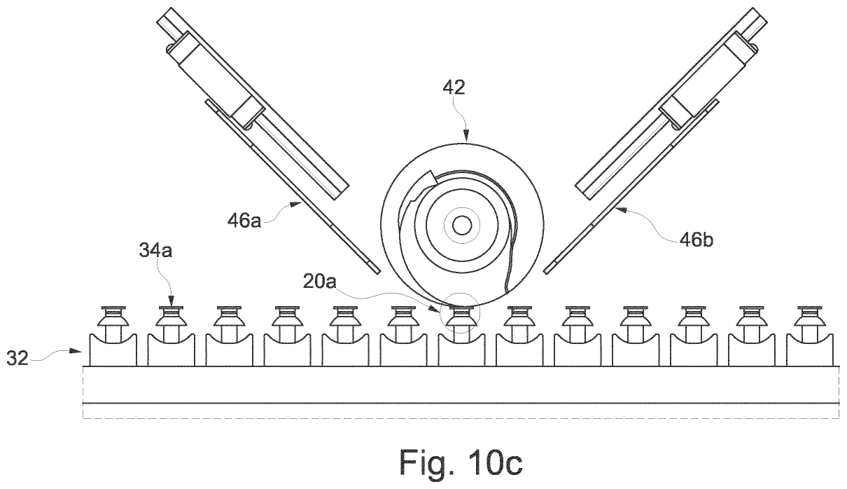

FIGS. 10a-10c show the system comprising the application component of FIGS. 8-9. The application system 40 comprises the application component 42 as well as two guide elements 46a, 46b. The guide elements 46a, 46b each comprise a screw guide element. The screw guide elements are shown in a closed configuration in FIG. 10b.

In the closed configuration shown in FIG. 10b, the guide elements 46a, 46b, and more specifically, the screw guide elements, enclose a section of the screw 52 and form a clearance. The clearance in FIG. 10b accommodates the screw 20a. Further, the dimensions of the clearance in FIG. 10b ensure contact between the spring 20a, the screw 52 and the guide elements 46a, 46b. Thus, optionally advantageously, the guide elements support transport and elongation of the spring 20a.

FIG. 10c shows the guide elements 46a, 46b in an opened configuration. In the opened configuration, the spring 20a is not enclosed by the guide elements 46a, 46b and the application component 42. As can be seen, the application component 42 is moved towards the receiving level 32. The application component 42 pushes the spring 20a on a row of pins 24a.

Optionally advantageously, the friction element 54 holds in place spring 20a while spring 20a is pushed on the pins 34a and hence increases reliability of the system and method.

In the example of FIGS. 10a-10c, the spring 20a contacts the friction element 54 when the spring is pushed onto pins 34, 34b, e.g., downwards. The pushing movement may cause a deformation of a cross-section of the coil 20a. Thus, the spring 20a may be pushed further into the screw helixes and thus contact the friction element 54. In particular, a meander-like deformation of the spring 20a in response to the pushing onto the pins 34a, 34b may be mitigated optionally advantageously. The system 30 is configured for moving the application component 42 shown in FIGS. 8-12c in a direction orthogonal to the receiving level 32. Thus, optionally advantageously, springs 20a can be picked from the storage and/or the tray.

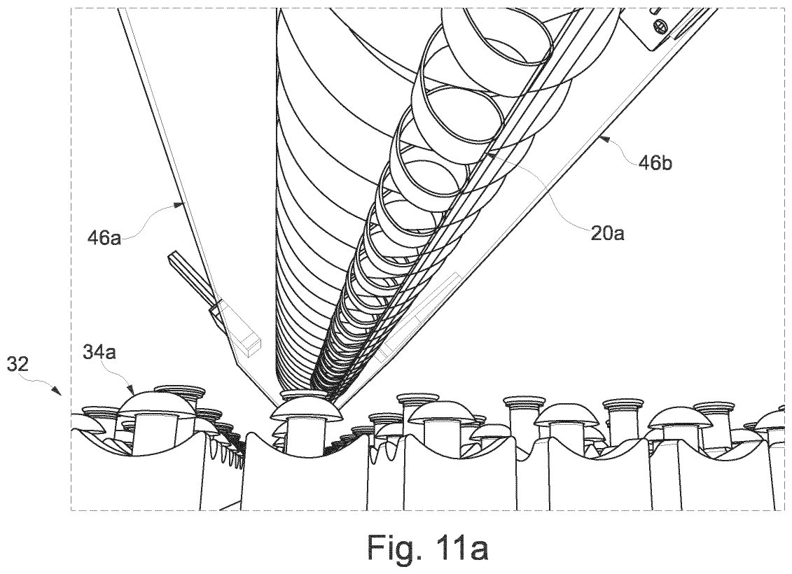

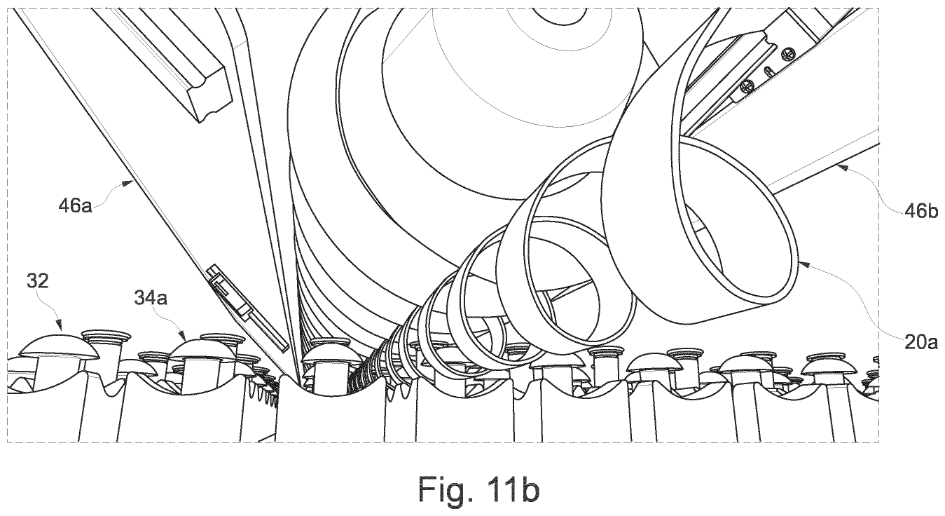

FIGS. 11a and 11b show another embodiment of the method.

In a first step, a spring 20a moves to a tray and/or a feed component. The tray may for example comprise a latch that opens. Thus, the spring may fall through a pipe into the application system 40. The screw guide elements are in the closed configuration.

An optical sensor (not shown) at the first end of the application component 42 detects a presence of the spring. A control system may cause the drive system to rotate screw 52. The screw 52 may pull the spring 20a along the application system 40 and elongate the spring 20a.

Another optical sensor at a second end of the application component 42 detects a presence of the spring. The control system controls the drive system so as to stop rotating the screw 52. The spring 20a is now in the elongated state stretched along the application component 42. This state is shown in FIG. 11a.

In another step, the application component 42 moves above the receiving level 32, particularly just above the pins 34a, 34b of the receiving level. In the example of FIG. 11a, the application component moves along the axis substantially orthogonal to the receiving level 32.

The guide elements 46a, 46b comprising the screw guide elements assume the opened configuration. Thus, optionally advantageously, the spring 20a can be pushed on the receiving level 32, while the application component 42 is further lowered. The spring 20a is then pushed on the pins 34a, 34b.

FIG. 11b shows a state after the spring 20a has been applied to the receiving level 32, while the screw guide elements are still in the opened configuration.

Subsequently, the application component 42 moves again from the receiving level 32 towards the storage component, such as the tray. The application component 42 is then supplied with a next spring.

The above steps are repeated until the springs 20a, 20b, 20c, 20d, 20e, 20f of the first layer are placed. As discussed above, between adjacent springs of the first layer, one row of pins 34a, 34b is left free.

After the first layer is placed on the receiving level 32, the receiving level 32 is rotated by 90° with respect to the application component 42.

In a subsequent step, the springs 24a, 24b, 24c, 24d, 24e, 24f of the second layer are applied to the receiving level 32. The application of the second layer is performed as the application of the first layer. However, there is no free row of pins 34a, 34b between adjacent springs 24a, 24b, 24c, 24d, 24e, 24f of the second layer.

After the second layer is placed on the receiving level 32, the receiving level 32 is again rotated by 90° with respect to the application component 42.

In another subsequent step, the springs 22a, 22b, 22c, 22d, 22e of the third layer are applied to the receiving level 32. The springs of the third layer are placed on the rows of pins 34a, 34b between the springs 20a, 20b, 20c, 20d, 20e, 20f of the first layer.

As discussed with respect to FIGS. 6a-6c, the product 10 is then separated from the receiving level 32 by means of the separating component and trimmed.

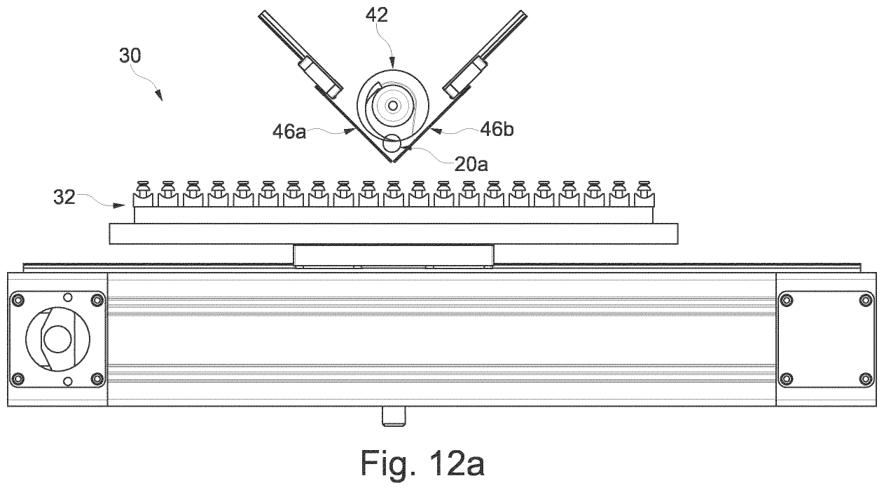

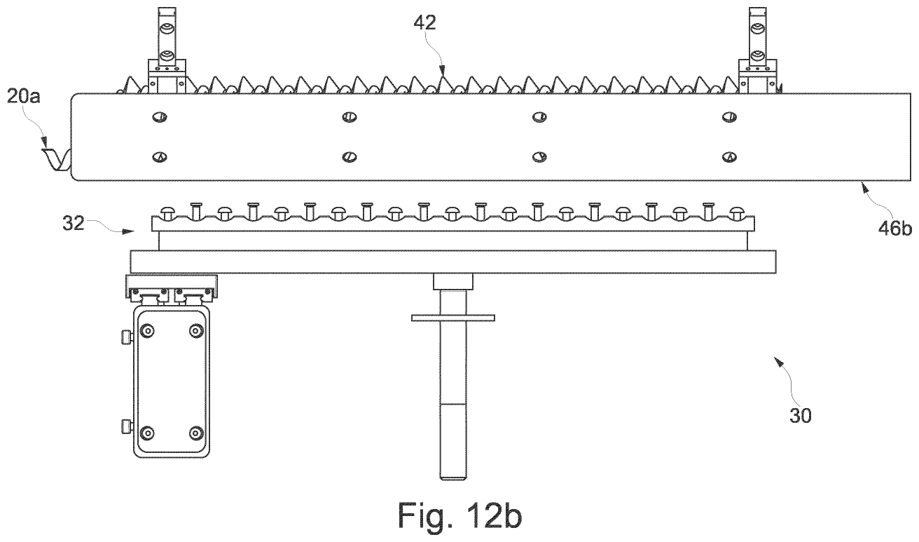

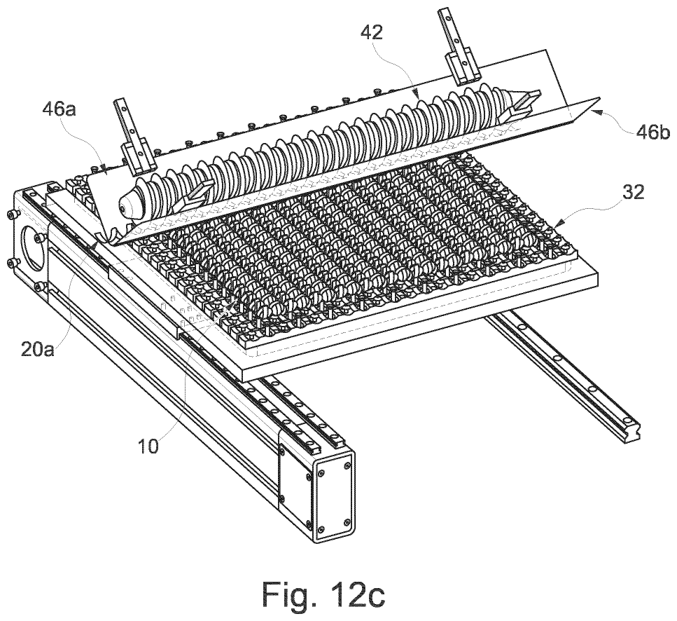

FIGS. 12a, 12b and 12c show three different perspectives of an exemplary embodiment of the system 30. As can be seen, receiving level 32 can be rotated around a substantially vertical axis. Further, in the example of FIGS. 12a-12c, receiving level 32 is mounted to a linear bearing, allowing to move the receiving level with respect to the application component 42 along an axis parallel to the receiving level and perpendicular to a longitudinal axis of the screw 52 of the application component 42.

In FIGS. 12a-12c, the closed configuration of the screw guide elements is shown.

In the Figures, a drive component 48 of the drive system is shown in FIGS. 7a, 7b, 7c. The person skilled in the art will however easily understand that other parts of the system that are described to be moved or to perform a movement also comprise a connection to at least one drive component. The drive system comprises these drive components.

Further, reference is made to the control system. The control system comprises a data-processing system. The control system is configured for controlling the drive system. In particular, the control system is configured for controlling the drive component(s).

The data processing system may comprise one or more processing units configured to carry out computer instructions of a program (i.e. machine readable and executable instructions). The processing unit(s) may be singular or plural. For example, the data-processing system may comprise at least one of CPU, GPU, DSP, APU, ASIC, ASIP or FPGA. The data processing system may comprise memory components, such as, main memory (e.g. RAM), cache memory (e.g. SRAM) and/or secondary memory (e.g. HDD, SDD). The data processing system may comprise volatile and/or non-volatile memory such an SDRAM, DRAM, SRAM, Flash Memory, MRAM, F-RAM, or P-RAM. The data processing system may comprise internal communication interfaces (e.g. busses) configured to facilitate electronic data exchange between components of the data processing system, such as, the communication between the memory components and the processing components. The data processing system may comprise external communication interfaces configured to facilitate electronic data exchange between the data processing system and devices or networks external to the data processing system. For example, the data processing system may comprise network interface card(s) that may be configured to connect the data processing system to a network, such as, to the Internet. The data processing system may be configured to transfer electronic data using a standardized communication protocol. The data processing system may be a centralized or distributed computing system.

The data processing system may comprise user interfaces, such as:
output user interface, such as:
   screens or monitors configured to display visual data (e.g. displaying graphical user interfaces of the questionnaire to the user),
   speakers configured to communicate audio data (e.g. playing audio data to the user),
input user interface, such as:
   camera configured to capture visual data (e.g. capturing images and/or videos of the user),
   microphone configured to capture audio data (e.g. recording audio from the user),
   keyboard configured to allow the insertion of text and/or other keyboard commands (e.g. allowing the user to enter text data and/or other keyboard commands by having the user type on the keyboard) and/or
   trackpad, mouse, touchscreen, joystick-configured to facilitate the navigation through different graphical user interfaces of the questionnaire.

To put it simply, the data processing system may be a processing unit configured to carry out instructions of a program. The data processing system may be a system-on-chip comprising processing units, memory components and busses. The data processing system may be a personal computer, a laptop, a pocket computer, a smartphone, a tablet computer. The data processing system may be a server, a server system, a portion of a cloud computing system or a system emulating a server, such as a server system with an appropriate software for running a virtual machine. The data processing system may be a processing unit or a system-on-chip that may be interfaced with a personal computer, a laptop, a pocket computer, a smartphone, a tablet computer and/or user interfaces (such as the upper-mentioned user interfaces).

While in the above, a preferred embodiment has been described with reference to the accompanying drawings, the skilled person will understand that this embodiment was provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

### NUMBERED REFERENCE SIGNS

10 product
20 parallel springs of first layer of springs
24 parallel springs of second layer of springs
22 parallel springs of third layer of springs
30 system
32 receiving level
34 pins
40 application system
42 application component, e.g. sprocket, sprockets, application roller or screw gripper
44 tube
46 guide element, e.g. pushdown blade or angular blades
48 drive component
52 screw
54 friction element

1. A product, comprising a plurality of layers of springs, each layer comprising a plurality of substantially parallel springs,
wherein a second layer of springs is placed on a first layer of springs, and
wherein the springs of the first layer are rotated by 60° to 120°, with respect to the springs of the second layer.

2. The product according to claim 1, wherein the plurality of layers comprises at least three layers of springs, each layer comprising a plurality of substantially parallel springs,
wherein a third layer of springs is placed on the second layer,
wherein the springs of the second layer are rotated by 80° to 100°, with respect to the springs of the third layer, and
wherein the springs of the first layer are rotated by 80° to 100°, with respect to the springs of the second layer.

3. The product according to claim 1, wherein the springs of a same layer are not interlaced, and
wherein the springs of each layer are interlocked with springs of at least one of the other layers.

4. The product according to claim 1, wherein the springs each comprise a flexible strip of material spirally wound along a longitudinal axis of the spring, and
wherein the springs comprise a substantially identical step in a substantially unbiased state.

5. The product according to claim 1, wherein the springs are substantially made from wood and/or an at least partially woody plant.

6. The product according to claim 2, wherein in a projection orthogonal to layer planes, the springs of the first layer and the third layer are placed alternatingly.

7. The product according to claim 1, wherein the product is a mat.

8. The product according to claim 1, wherein the springs comprise a woody material consisting of at least one of wood and a woody portion of an at least partially woody plant, wherein a mass fraction of the woody material in the springs amounts to at least 50%.

9. A system for processing a plurality of springs, comprising:
a product support system, and
a spring application system,
wherein the product support system comprises a receiving level configured for receiving a plurality of layers of springs,
wherein each layer comprises a plurality of springs,
wherein the springs in each layer are substantially parallel,
wherein the receiving level comprises a plurality of pins, and
wherein the spring application system is configured for applying the plurality of springs to the product support system.

10. The system according to claim 9, wherein the product support system further comprises a separating component configured for separating the plurality of springs from the receiving level and a trimming component,
wherein the trimming component is configured for trimming edges of the layers of springs.

11. The system according to claim 9, wherein the pins are arranged along a rectangular grid, and
wherein the pins are substantially equally spaced along the grid by a grid step.

12. The system according to claim 11, wherein the springs comprise a substantially identical step in a substantially unbiased state, and
wherein the grid step is greater than a step of the springs.

13. The system according to claim 9, wherein the spring application system comprises a drive system, a feed system and at least one application component.

14. The system according to claim 13, wherein the system comprises a control system configured for controlling an operation of the system,
wherein the control system comprises a data-processing system, and
wherein the control system is configured for controlling the drive system.

15. The system according to claim 13, wherein the at least one application component comprises at least one or a plurality of guide element(s).

16. The system according to claim 13, wherein the at least one application component comprises at least one or a plurality of profiled wheel(s), wherein the profiled wheel(s) comprise teeth and/or forks around a circumference of the profiled wheel(s).

17. The system according to claim 16,
wherein the guide element(s) comprise a plurality of side supporting elements at sides of the profiled wheel(s) around circumference(s) of the profiled wheel(s), and/or
wherein the application system comprises a synchronizing system configured for applying a force and/or torque onto a received spring in a direction opposite to a feeding direction.

18. The system according to claim 15, wherein the at least one application component comprises a screw,
wherein the drive system is configured for rotating the screw, and
wherein the guide element(s) comprise at least two screw guide elements.

19. A method, comprising
providing a plurality of springs,
placing a first plurality of the springs in a first layer, and
placing a second plurality of springs in a second layer on the first layer of springs,
wherein the springs in each layer are substantially parallel,
wherein the springs in the first layer are rotated by 60° to 120°, with respect to the springs in the second layer.

20. The method according to claim 19, further comprising
placing a third plurality of springs in a third layer on the second layer,
wherein the springs in the first layer are rotated by 80° to 100°, with respect to the springs in the second layer, and
wherein the springs in the second layer are rotated by 80° to 100°, with respect to the springs in the third layer.

21-26. (canceled)
